(19) United States
(12) Patent Application Publication
(10) Pub. No.: US 2007/0214077 A1
(43) Pub. Date: Sep. 13, 2007

(54) SYSTEMS AND METHODS FOR ASSET BASED LENDING (ABL) VALUATION AND PRICING

(75) Inventors: Robert L. Barnes, London (GB); Daniel L. Duncan, Atlanta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PrimeRevenue, Inc., Atlanta, GA (US)

(21) Appl. No.: 11/677,488

(22) Filed: Feb. 21, 2007

Related U.S. Application Data
(60) Provisional application No. 60/746,663, filed on May 8, 2006.
(60) Provisional application No. 60/780,317, filed on Mar. 8, 2006.
(60) Provisional application No. 60/775,045, filed on Feb. 21, 2006.

(51) Int. Cl. G06Q 40/00

(52) U.S. Cl. 705/38

(57) ABSTRACT

An automated asset based lending (ABL) system that integrates supplier receivables data, allowing financial institutions optimally to value and price lending against those receivables, thus enabling financial institutions to offer suppliers a maximum borrowing base with minimum risk and highest return to the financial institution, further enabling the financial institution to conduct business in multiple currencies, time zones and countries using a computer based ABL process. In an asset based lending system having a client and at least one financial institution, a method for valuing and pricing client's receivables, the method comprising, downloading accounts receivable information from the client, the accounts receivable information having a specified currency, calculating a borrowing base for the client via utilizing debtor risk ratings, pricing profiles, valuation profiles and pricing tiers, and applying fees and interest as specified in the pricing profile associated with the valuation profile.

### CROSS REFERENCE TO RELATED APPLICATIONS

This application claims the benefit under 35 U.S.C. §119(e) of U.S. Provisional Patent Application Ser. No. 60/746,663, entitled “Improved System and Methods for ABL Valuation and Pricing,” filed May 8, 2006, No. 60/780,317, entitled “System and Methods for ABL Valuation and Pricing,” filed Mar. 8, 2006, and No. 60/775,045, entitled “Structure for Asset Based Lending System,” filed Feb. 21, 2006, each of which is incorporated herein by reference as if set forth herein in its entirety.

### FIELD OF THE PRESENT INVENTION

The present invention relates generally to electronic commerce financing, and more particularly, to automated asset based lending (ABL) systems that integrate supplier receivables data, allowing financial institutions optimally to value and price lending against those receivables, thus enabling financial institutions to offer suppliers a maximum borrowing base with minimum risk and highest return to the financial institution, further enabling the financial institution to conduct business in multiple currencies, time zones and countries using a computer based ABL process.

### BACKGROUND OF THE PRESENT INVENTION

Many financial institutions (FIs) have lending programs whereby they purchase all or part of a client's receivables; some of these lending programs fit into an asset based lending (ABL) category. In a typical ABL program, invoices are created when a financial institution's client provides goods and services to its customers. For the purposes of this disclosure, the client's “customers” are synonymous with “debtors.”

To obtain working capital, the financial institution's client sells its receivables at a discount to the financial institution. This process can be lengthy and primarily consists of paper-based transactional processing. Typically, a client must provide the financial institution with detailed invoice level receivables paperwork and follow up with substantial documentation and proof of invoice validity prior to obtaining cash for those receivables. This approach is often problematic as the client's entire receivable base is usually devalued due to inaccurate debtor credit ratings and invoice details. A lack of visibility to debtor concentrations across the client base is also indistinguishable. As a result, the client often receives higher rates, a reduced borrowing base, and less money for its receivables. In addition, the global marketplace provides unique challenges for financial institutions that conduct ABL programs in multiple countries, time zones, and currencies.

In today's global economy, financial institutions need automated solutions that integrate supplier receivables data, allowing the financial institution optimally to value and price lending against those receivables. Ideally, such solutions should provide the accuracy and accountability to enable financial institutions to offer suppliers a maximum borrowing base with minimum risk and highest return to the financial institution. For these and many other reasons, there is a need for automated ABL systems that enable the financial institution to conduct business in multiple currencies, time zones and countries using a computer based ABL lending process.

### SUMMARY OF THE INVENTION

The present invention relates generally to electronic commerce financing and, more particularly, to automated asset based lending (ABL) systems that integrate supplier receivables data, allowing financial institutions optimally to value and price lending against those receivables, thus enabling financial institutions to offer suppliers a maximum borrowing base with minimum risk and highest return to the financial institution, further enabling the financial institution to conduct business in multiple currencies, time zones and countries using a computer based ABL process.

One aspect of the present invention provides in an asset based lending system having a client and at least one financial institution, a method for valuing and pricing client's receivables, the method comprising, downloading accounts receivable information from the client, the accounts receivable information having a specified currency, calculating a borrowing base for the client via utilizing debtor risk ratings, pricing profiles, valuation profiles and pricing tiers, and applying fees and interest as specified in the pricing profile associated with the valuation profile.

Another aspect of the present invention provides an asset based lending system having a client and at least one financial institution, a method for valuing and pricing client's receivables, the method comprising, receiving accounts receivable information from the client, managing valuations, pricing and risk for the accounts receivable information, applying fees and utilizing the valuations to calculate a borrowing base, receiving a draw request from the client, transferring funds to the client's operating account, receiving a deposit from the client, and upon notification of the deposit, re-calculating the borrowing base utilizing draw request information, deposit information and valuations.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a high level overview of an asset based lending (ABL) system.

FIG. 2 is a high level architecture view of the ABL system of FIG. 1.

FIG. 3 is a diagram illustrating the interrelationship of the elements in an ABL application.

FIG. 4 is a diagram illustrating client element relationships in an ABL application.

FIG. 5 is a diagram illustrating debtor element relationships in an ABL application.

FIG. 6 is a diagram illustrating client ledger element relationships in an ABL application.

FIG. 7 is a diagram illustrating debtor ledger element relationships in an ABL application.

FIG. 8 is a diagram illustrating client program element relationships in an ABL application.

FIG. 9 is a diagram illustrating valuation profile element relationships in an ABL application.

FIG. 10 is a screen image illustrating an example valuation profile in an ABL application.

FIG. 11 is a diagram illustrating a method for valuation profile creation in an ABL application.

FIG. 12 is a diagram illustrating a method for fine-tuning a valuation profile in an ABL application.

FIG. 13 is a diagram illustrating a method for borrowing base calculation in an ABL application.

FIG. 14 is an example illustrating a client's accounts receivable book in an ABL application.

FIG. 15 is an example illustrating a method for using pricing profile to determine borrowing base in an ABL application.

FIG. 16 is an example illustrating results from applying a valuation profile against reorganized accounts receivable debtors in an ABL application.

FIG. 17 is a screen image illustrating an example pricing profile in an ABL application.

FIG. 18 is a screen image illustrating an example interest rates list in an ABL application.

FIG. 19 is a screen image illustrating an example interest rate detail in an ABL application.

FIG. 20 is a screen image illustrating an example related pricing profile in an ABL application.

FIG. 21 is a screen image illustrating an example interest rate detail—past rates tab in an ABL application.

FIG. 22 is a screen image illustrating an example interest rate detail—history tab in an ABL application.

FIG. 23 is a diagram illustrating verification profile element relationships in an ABL application.

FIG. 24 is a diagram illustrating an example group hierarchy of a financial institution in an ABL application.

FIG. 25 is a screen image illustrating an example group list of the financial institution in an ABL application.

FIG. 26 is a screen image illustrating an example group details in an ABL application.

FIG. 27 is a screen image illustrating an example workflow in an ABL application.

FIG. 28 is a diagram illustrating client/debtor portfolio element relationships in an ABL application.

FIG. 29 is a diagram illustrating ABL application electronic documents.

FIG. 30 is a diagram illustrating ABL application electronic documents.

FIG. 31 is a screen image illustrating an example draw page in an ABL application.

FIG. 32 is a screen image illustrating an example recovery refund page in an ABL application.

FIG. 33 is a screen image illustrating an example invoice page in an ABL application.

FIG. 34 is a screen image illustrating an example cash application page in an ABL application.

FIG. 35 is a screen image illustrating an example credit memo page in an ABL application.

FIG. 36 is a screen image illustrating an example journal entry page in an ABL application.

FIG. 37 is a screen image illustrating an example deposit page in a ABL application.

FIG. 38 is a screen image illustrating an example electronic funds transfer page in an ABL application.

FIG. 39 is a screen image illustrating an example batch list page in an ABL application.

FIG. 40 is a screen image illustrating an example debtor batch list page in an ABL application.

FIG. 41 is a screen image illustrating an example invoice batch list page in an ABL application.

FIG. 42 is a diagram illustrating the client element web page design in an ABL application.

FIG. 43 is a screen image illustrating an example client list page in an ABL application.

FIG. 44 is a screen image illustrating an example client details page in an ABL application.

FIG. 45 is a screen image illustrating an example client ledgers list page in an ABL application.

FIG. 46 is a screen image illustrating an example client ledger details page in an ABL application.

FIG. 47 is a diagram illustrating the debtor element web page design in an ABL application.

FIG. 48 is a screen image illustrating an example debtor list page in an ABL application.

FlG. 49 is screen image illustrating an example debtor details page in an ABL application.

FIG. 50 is a diagram illustrating the image elements web page design in an ABL application.

FIG. 51 is a screen image illustrating an example interest rates list page in an ABL application.

FIG. 52 is a screen image illustrating an example interest rates detail page in an ABL application.

FIG. 53 is a screen image illustrating an example pricing profile list page in an ABL application.

FIG. 54 is a screen image illustrating an example pricing profile details page in an ABL application.

FIG. 55 is a screen image illustrating an example valuation profile list page in an ABL application.

FIG. 56 is a screen image illustrating an example valuation profile details page in an ABL application.

FIG. 57 is a screen image illustrating an example client program list page in an ABL application.

FIG. 58 is a screen image illustrating an example client program details page in an ABL application.

FIG. 59 is a screen image illustrating an example verification profile list page in an ABL application.

FIG. 60 is a screen image illustrating an example verification profile details page in an ABL application.

### DETAILED DESCRIPTION OF PREFERRED EMBODIMENTS

Reference is now made in detail to the description of the embodiments as illustrated in the drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

The present invention relates generally to electronic commerce financing and, more particularly, to improved asset based lending (ABL) systems and methods for enabling financial institutions (FI) and their clients to collaborate across multiple accounts receivables in multiple currencies and languages.

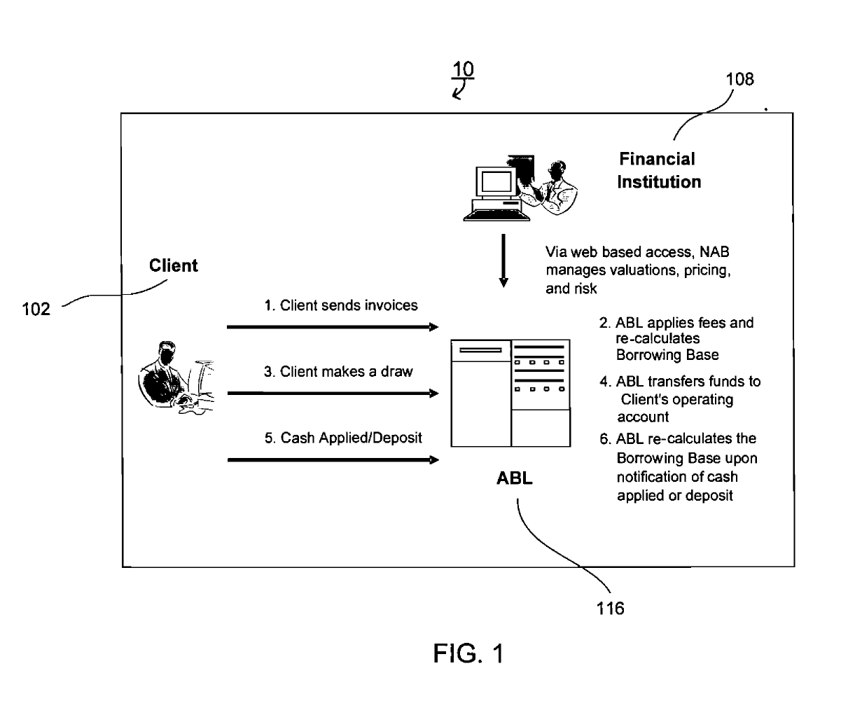

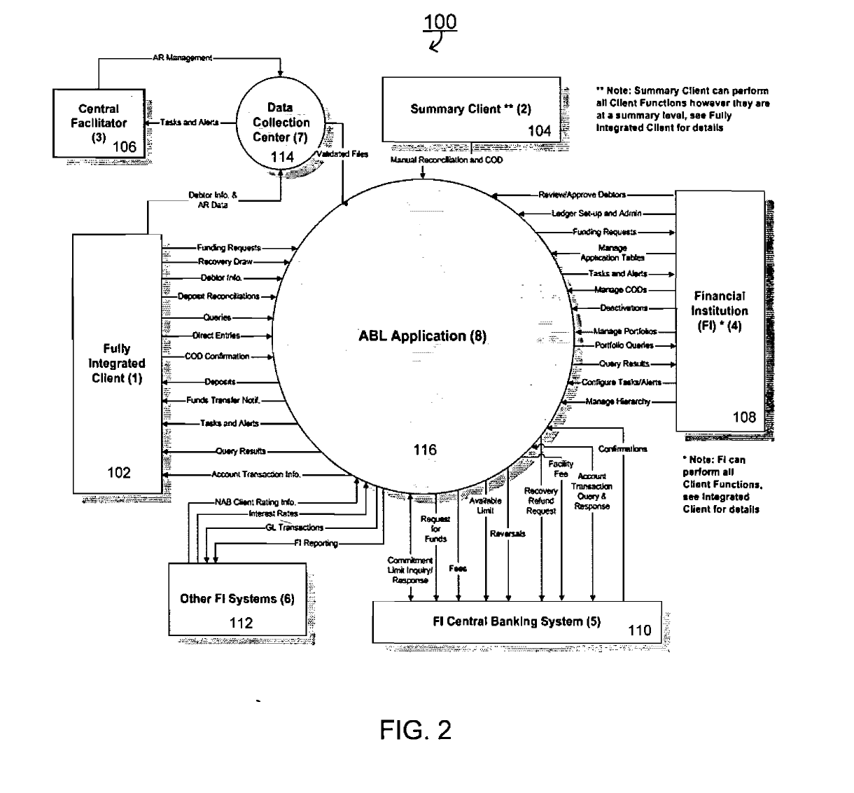

FIG. 1 illustrates a high level functional overview 10 of an asset based lending system. An ABL application 116 integrates the client's accounts receivables with the financial institution's 108 internal banking systems on an ABL platform. The ABL application 116 values the client's borrowing base, thus enabling the client 102 to conduct real-time funding against the newly-calculated borrowing base. The ABL application 116 typically is fully integrated with the financial institution's banking system and, as such, the application software is preferably hosted behind the financial institution's firewall. The ABL system 100 (see FIG. 2) also includes automated risk scoring, portfolio management, ledger and deposit reconciliation, as well as tasks and alerts. Financial institutions 108 and their clients 102 are effectively enabled to perform financial transactions globally, across multiple time zones, in any currency, on a single platform, and in real time.

The system provides an internal application structure based upon a set of functional building blocks. This building block concept provides financial institutions 108 with a flexible and configurable ABL application 116 solution that minimizes system management and maximizes lending capability.

Further, the ABL system 100 provides an innovative solution for valuing and pricing the client's receivables, via the building blocks inherent in the ABL application 116 in conjunction with debtor risk ratings, pricing profiles, valuation profiles and pricing tiers dynamically to determine and value the client's borrowing base.

System generated risk ratings are calculated for each debtor using financial institution 108 configured risk score criteria along with system generated risk scoring. Valuation profiles are associated to pricing profiles and contain configurable valuation tiers. The pricing profiles include various fees and interest rates. The valuation tiers configured in the valuation profile determine (1) the number of debtors to apply against the pricing tier based on the debtor's risk score, (2) the percentage of any one debtor's receivables to be included in the borrowing base, (3) the age of any one debtor's receivables to be included in the borrowing base and (4) the percentage of any specific tier's debtors to be included in the borrowing base.

A borrowing base is calculated for each client. Fees and interest are applied in various ways, as specified in the pricing profile associated with the valuation profile. Although this is a separate process from the valuation process, it applies to the invoice selected as a result of the valuation process.

As shown in FIG. 1, the ABL system enables the financial institution 108 to value clients' account receivables and provide funding in a real-time environment. The ABL system includes distinct user types or entities. (1) clients 102 are customers of the financial institution 108 that interactively utilize the ABL system 100 for obtaining receivables based funding. (2) A single financial institution requires an automated process for managing and monitoring the ABL lending process. (3) A third party provider, or central facilitator, of data collection center services supports and sustains downloading and data harmonization of client receivable data.

The ABL application 116 provides the financial institution 108 with a host of processes, including (1) fully integrated client processes, (2) summary client processes, (3) general ABL application processes, (4) financial institution process, (5) financial institution banking system integration processes, (6) other financial institution back office system integration processes and (7) data collection center processes.

Referring again to FIG. 1, the bank or financial institution 108 manages valuations, pricing and risk. A client sends invoices to the ABL application 116. The ABL application 116 applies fees and re-calculates the borrowing base. Once the client makes a draw, the ABL application 116 transfers funds to the client's operating account. When case is applied or when a deposit is made, the ABL application 116 re-calculates the borrowing base upon notification of the cash applied or the deposit respectively.

FIG. 2 illustrates the high level architecture of the ABL system 100, including the processes and entities, as well as the data flow between these processes and entities. The ABL application 116 interacts with a fully integrated client 102 (client 102), a summary client 104, a central facilitator 106 (third party provider), a financial institution 108, FI central banking system 110, other FI systems 112, and a data collection center 114.

The data flow between the ABL application 116 and a fully integrated client 102 includes functionality such as (1) funding requests, (2) recovery draw, (3) debtor information, (4) deposit reconciliations, (5) queries, (6) direct entries, (7) certificate of debtor (COD) confirmation, (8) deposits, funds transfer notification, (9) tasks and alerts, (10) query results and (11) account transaction information.

The fully integrated client 102 provides debtor information and accounts receivable data to the data collection center 114. Accounts receivable upload options include (1) an integrated interface for client with certain accounts receivable packages, e.g. MYOB, (2) an open interface model for clients that desire to upload their data using a central facilitator defined file format, and (3) a non-standard option for clients that either have an accounts receivable package where no integration agent has been developed or that choose not to use an integration agent, even if one is available. Home page functions are used to manage debtors, funding requests, tasks and alerts, and accounts receivables. In addition, the fully integrated client may submit funding requests, access bank account information, view and manage the reserve/recovery account, manage debtors, view ledger details, certificate of debtors/reconciliation, and view electronic documents.

The summary client 104 provides for manual reconciliation and COD to the ABL application 116. The summary client 104 uses system functionality to directly enter summary level accounts receivable information. Further, the summary client 104 is designed for clients 102 that cannot upload detailed accounts receivables data. Finally, it should be noted that summary clients 104 can perform any functions available to the fully integrated client 102, with the exception of detailed data uploads and associated detailed reconciliations. The client 102 functions are performed at a summary level.

Accounts receivable management is provided from the central facilitator 106 to the data collection center 114. The central facilitator 106 performs data mapping for new clients 102 using the non-standard translation method. Further, the central facilitator 106 responds to tasks and alerts from the data collection center 114. Finally, the central facilitator 106 works with financial institutions 108 for enabling and managing client accounts.

The data flow between the ABL application 116 and the financial institution 108 includes functionality such as (1) review and approval of debtors, (2) ledger set-up and administration, (3) funding requests, (4) management of application tables, (5) viewing tasks and alerts, (6) management of CODs, (7) deactivations, (8) management of portfolios, (9) portfolio queries, (10) query results, (11) configuration of tasks and alerts and (12) management of hierarchy. It should be noted that the financial institution 108 is capable of performing any client functions.

The financial institution 108 interactively uses the capabilities available in the ABL application 116 to set-up and manage all ABL application 116 functionality. Home page functions are used to manage financial institution 108 clients 102, funding requests, tasks and alerts, and accounts receivables review funding request.

The data flow between the FI central banking system 110 and the ABL application 116 includes functionality such as (1) confirmations, (2) account transaction query and response, (3) facility fee, (4) recovery refund request, (5) reversals, (6) available limit, (7) fees, (8) request for funds and (9) commitment limit inquiry and response. The ABL application 116 integrates directly to the financial institution's banking system and provides for real-time funding requests, real-time client refunds of unapplied cash, real-time bank account transaction information and performs transaction validation and confirmation.

Other FI systems 112 may also interact with the ABL application 116 and the data flow includes functionality such as (1) financial institution reporting, (2) GL transactions, (3) interest rates and (4) bank client rating information. Financial institution client information, interest rates, bank accounts, and account status are capable of being uploaded to the ABL application. The financial institution central banking system may download GL transactions and other financial institution reporting information to financial institutions 108 and other back office systems.

The data collection center 114 provides validated files to the ABL application 116. Data is transported between the client 102 and the data collection center 114 and also between the ABL application 116 and the data collections center 114. Non-standard translation management provides requirements and implementation structure for those clients 102 that do not use the central facilitator's 106 standard extract and transport agents. The data collection center 114 also provide data validation to correct for structure errors, duplicate records and data reasonableness (not business rules). Disaster recovery is also provide supported and expedited. Activity monitoring allows for the monitoring of users, client information and transactions. Tasks and alerts specific to the management of the data collection center are also provided. Reports such as, for example, a financial institution transmission report may be provided. The data collection center 114 also provides for integrated client version management.

The ABL application 116 provides functionality including (1) allowing for client and ledger configuration, (2) establishment of financial institution hierarchical organization structure, (3) management of debtor/client risk ratings, (4) portfolio organization, management and query analysis, (5) real-time integration to financial institution banking applications, (6) task management of debtors and electronic documents, (7) configuration of alert processing and financial institution/client user notification, (8) funding approvals, (9) debtor management, (10) permission management within the system, (11) data capture and online query for all key system audit events, (12) processing of deposits and deposit reconciliations, (13) client borrowing base calculation, (14) detailed account reconciliation, (15) batch management processing, (16) client refunds and (17) client bank account inquiries.

ABL Application Elements

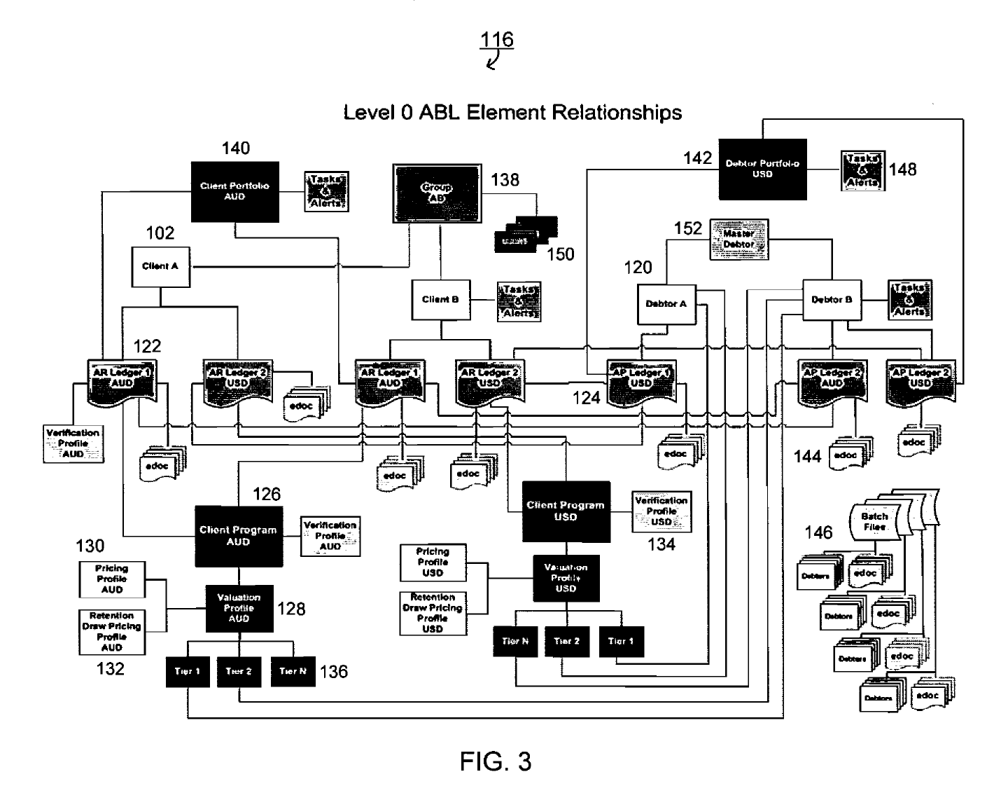

The architecture as shown in FIG. 2 includes a flexible set of application elements that are building blocks in the configuration and processing performed within the ABL application 116. FIG. 3 is a diagram illustrating the interrelationship of the ABL elements, or building blocks in an ABL application 116.

The client element allows the customers of the financial institutions 108 to submit account receivables. The accounts receivables are valued and a specific facility is made available to the client 102 from which they may perform draws.

The debtor 120 pays the clients 102 for the goods and services provided by the client 102. The debtor 120 element is cornerstone building block in the ABL application 116. Debtors 120 are important to the system 100 as the rating of the debtors affect (for better or for worse) the lending conditions that the clients 102 ultimately receive.

The accounts receivable ledger 122 (AR ledger 122) is provided by the client 102. Client ledgers allow for multi-currency capability enabling the financial institution 108 to manage the ABL lending process in any currency. The AR ledger 122 can be provided in summary or detail form. A more detailed and accurate AR ledger 122 allows the financial institution 108 to better determine the value of the ledger. Clients 102 having ledgers that are consistently paid to terms with minimal dilution can be valued higher and can therefore receive better rates and fees. AR ledgers 122 are specific to a currency, and a client 102 can have any number of ledgers.

Debtor accounts payable ledgers 124 (AP ledger 124) provide visibility to debtor payment trends across multiple clients and currencies. A debtor 120 may have only one ledger per currency.

Client programs 126 reduce the maintenance effort for managing clients 102 with like attributes. Client programs 126 allow the financial institution 108 to group client ledgers having similar characteristics. The financial institution 108 can then associate a single verification profile with many client ledgers, thus simplifying system maintenance. The client program 126 also identifies instances where the client programs' 126 associated valuation profile and verification profile would be affected by modifications.

The valuation profile 128 is the method used to value debtors invoices and calculate the borrowing base for the client. The valuation profile 128 includes pricing profiles 130 and tiers 134. The pricing profile 130 determines the rates and fees applied to the client's facility when creating a draw. The tiers 134 are used to segregate debtors 120 into groups based on their financial rating. The tiers 134 determine how much of any one debtor's invoices can make up the client's 102 borrowing base. A valuation profile 128 can be associated to a client program 126 or directly to a client's accounts receivable. Valuation profile 128 are currency specific and may not be associated with a client program 126 or client accounts receivable having a different currency. Valuation profile 128 can be used in any number of client programs 126. They also allow for identification of all instances where client programs 126 are affected by modifications to a specific valuation profile 128.

Pricing profiles 130 and valuation profiles 128 can be configured once and referenced any number of times by any number of valuation profiles 128. Pricing profiles 130 contain interest and fee information. This information is used to calculate the fees and interest associated with a draw. Pricing profiles 130 are currency specific and may not be associated with a valuation profile 128 of a different currency. They also allow for identification of all instances where client programs 126 would be affected by modifications to these profiles.

If used, the retention draw pricing profile 132 gives the financial institution 108 the option to allow the client 102 to borrow additional funds held in the client's retention account with rates and fees based on the settings contained in the retention draw pricing profile 132.

Tiers 134 are part of the valuation profile 128. A valuation profile 128 can have any number of tiers 134. Valuation tiers are established to value debtor's receivables in the accounts receivable ledger. The valuation profile 128 can have as many tiers 134 as the user desires. Tiers 134 are cross referenced to a specific group of debtors 120 (by their Tax ID number) or to a group of all debtors 120 by rating.

Verification profiles 136 provide a central location for managing most electronic document (e-document) exceptions and allow for reuse or separate configuration for client ledgers within a client program 126. Verification profiles 136 contain specific information that is used to validate against the client's invoice and debtor file. This information may consist of invoice minimum and maximum amounts or dates that apply to invoices contained in the accounts receivable. When invoice exceptions occur, any number of actions may be automatically initiated by the system. They also identify and initiate monetary approval and review functions.

Groups 138 enable the financial institution 108 to organize clients 102 and financial institution users. Groups 138 can be organized to represent the organizational or functional structure of the financial institution 108. This capability allows the financial institution 108 to effectively manage and action tasks and alerts for clients 102, debtors 120 and portfolios. Groups 138 are hierarchical building blocks. Financial institution users are assigned permissions and then associated to groups 138. Clients 102 are assigned to groups 138. In this way client tasks and alerts are assigned to users having the appropriate roles for the group 138 to which they and the client 102 belong.

Client portfolios 140 are used by the financial institution 108 to organize and manage their clients 102. Financial institutions 108 can use client portfolios 140 to help them track the performance of the portfolios they have been assigned. Portfolios allow the financial institution 108 to set alerts, view trends and capture dilution and other important information about their clients 102.

Debtor portfolios 142 are similar to client portfolios 140 except that the debtors 120 are organized into portfolios to allow the financial institution 108 to set alerts, view trends and capture dilution and other important information about their debtors 120.

Electronic documents 144 (e-documents 144) work interactively to provide the user with the capability to view document details, document history, attachments and link to other related documents seamlessly. Electronic documents 144 include credit memos, journal entries, electronic funds transfers, cash applications and invoices.

Batch 146 processing provides the capability to manage data records before they have been processed into the system. Batch files are created as part of the upload or direct entry process. Batch files contain electronic documents 144 records and/or debtor records. Records remain in the batch file until they have been appropriately processed into the system. Batches 146 can themselves can be reviewed and modified by the financial institution to suit the financial institution's 108 requirements.

Tasks and alerts 148 are configured by the financial institution 108 and can be associated to clients 102, debtors 120 and portfolios. Tasks and alerts 148 are the method by which workflow and notifications are managed within the ABL application 116. The ABL application 116 offers a full suite of tasks and alerts to help the financial institution 108 identify when important events occur or to perform various process related tasks.

Users 150, at the financial institution 108, are assigned permissions and then assigned to groups 138 within the hierarchy. Users 150 can then perform permission related tasks for the group 138 to which they are assigned.

The master debtor 152 provides the facility to identify all instances where a single debtor 120 is related to multiple client ledgers. When a client debtor is added to the system, if the debtor 120 already exists then a relationship is made between the new debtor 120 and the master debtor 152. This continues for as many times as the debtor 120 is added for a different client 102. This important feature enables the financial institution 108 to view the debtor 120 across all of its related clients 102. The master debtor 152 provides a powerful tool when assessing the debtors risk and changes to the debtor's risk score.

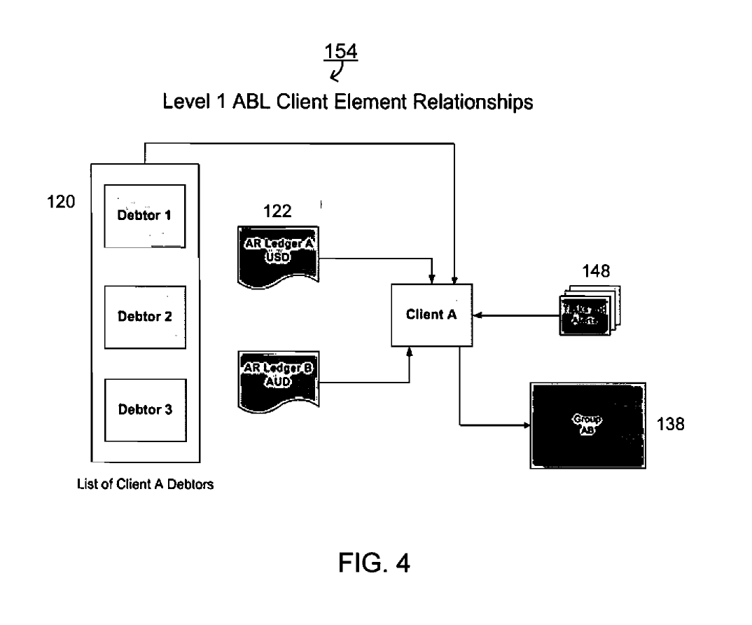

FIG. 4 is a diagram illustrating the client element ABL relationships 154. Clients have elements for (1) accounts receivable ledgers, (2) debtors, (3) tasks and alerts and (4) and groups.

The client 102 can have any number of AR ledger 122. Each AR ledger 122 specifies a currency. One of the primary reasons that AR ledgers 122 are currency specific is to allow for borrowing base calculations and funding of the accounts receivables in the currency specified in the AR ledger 122. If an AR ledger 122 contained accounts receivables data for multiple currencies, it would be difficult to value the AR ledger 122 due to constant changes in the base currency exchange rate. The present system enables the financial institution 108 to value the client's 102 account receivables in the currency of the AR ledger 122. This provides the financial institution 108 with an accurate picture of the borrowing base calculated for each AR ledger 122, and the client 102 knows exactly what the borrowing base is worth. AR ledgers 122 also facilitate the ability for the financial institution 108 to have multiple AR ledger 122 with different valuations based upon the debtor 120 concentration.

A client's 102 debtors 120 are associated to one or more client AR ledgers 122. The financial institution 108 can view all debtors 120 associated with a client 102 or choose to view an individual client AR ledger 122 and see all debtors 120 associated with that AR ledger 122. This capability enables (1) the debtor 120 to do business with the client 102 in multiple currencies and (2) the financial institution 108 to manage the debtor 120 separately for each AR ledger 122.

A limitless number of tasks and alerts 148 can be configured for a client 102. The tasks and alerts 148 apply to all of a client's AR ledger 122. This provides the financial institution 108 detailed visibility to monitor and manage the client and associated AR ledgers 122.

A client 102 can belong to only one group 138. Groups 138 are part of the hierarchy structure and enable the management of tasks and alerts 148. Groups 138 make it possible for the financial institution 108 to configure any organization or functional structure needed to manage their clients 102. Groups 138 control work flow. When tasks and alerts 148 are issued for a client 102, the users 150 that belong to that same group 138 will be the first to receive the task or alert 148. Groups 138 also contain business hours and holiday as well as time out parameters for tasks and alerts 148.

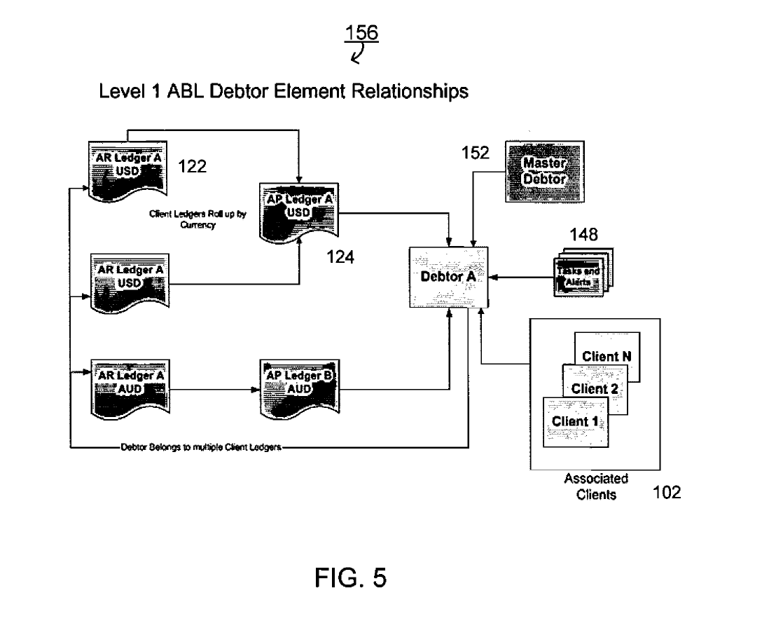

FIG. 5 is diagram illustrating the ABL debtor element relationships 156. Debtors 120 have elements for (1) client ledgers, (2) clients, (3) currency ledgers, (4) tasks and alerts and (5) and master debtor.

Debtors 120 are included in client AR ledgers 122. A debtor 120 may belong to any number of AR ledgers 122. The AR ledgers 122 are currency specific, as illustrated in FIG. 5 with AP ledger 124 (A) denoted in USD and AP ledger 124 (B) denoted in AUD. Debtor portfolios and AP ledgers 124 are both possible because of these relationships. Additionally, the accounts receivables associated with a debtor 120 are visible in detail and summary from the client AR ledger 122.

Debtors 120 are the client's customers. The client 102 will have every debtor 120 approved by the financial institution 108 prior to uploading any related accounts receivables information. Once the debtors 120 are approved, the associated accounts receivable can be processed as part of the borrowing base.

Because a debtor 120 may belong to any number of client AR ledgers 122, and since client AR ledgers 122 are currency specific, this unique relationship enables the system to provide a consolidated view of the debtors' accounts payable across the clients 102 having ledgers in the same currency. The consolidated view give the financial institution 108 a unique perspective of the debtors' 120 payment trends, credit rating, dilution, etc., across the debtors' clients in the ABL application 116. Additionally, the accounts payables associated with a debtor 120 are visible in detail and summary from the debtor's currency ledger.

A limitless number of tasks and alerts 148 may be configured for a debtor 120. The tasks and alerts 148 apply to all of the client AR ledgers 122 to which the debtor 120 belongs. This provides the financial institution 108 detailed visibility to monitor and manage the debtor 120 and its associated AP ledgers 124. An example alert might be to notify the responsible financial institution 108 when the debtor's credit rating reaches a predetermined level.

When a debtor 120 is added for a client 102, the system checks to see if the debtor 120 already exists within the system for the client 102. If the debtor 120 does not exist, then the system creates a master debtor 152 record to which the new debtor 120 is associated. If the debtor 120 already exists, then the system associates the new debtor 120 with the existing master debtor 152. Thus, the financial institution 108 may know all of the clients 102 to which a debtor 120 is associated. This is a powerful took when assessing changes to the debtor's risk score or understanding the percentage of the total borrowing base associated to that debtor 120 across all client AR ledgers 122.

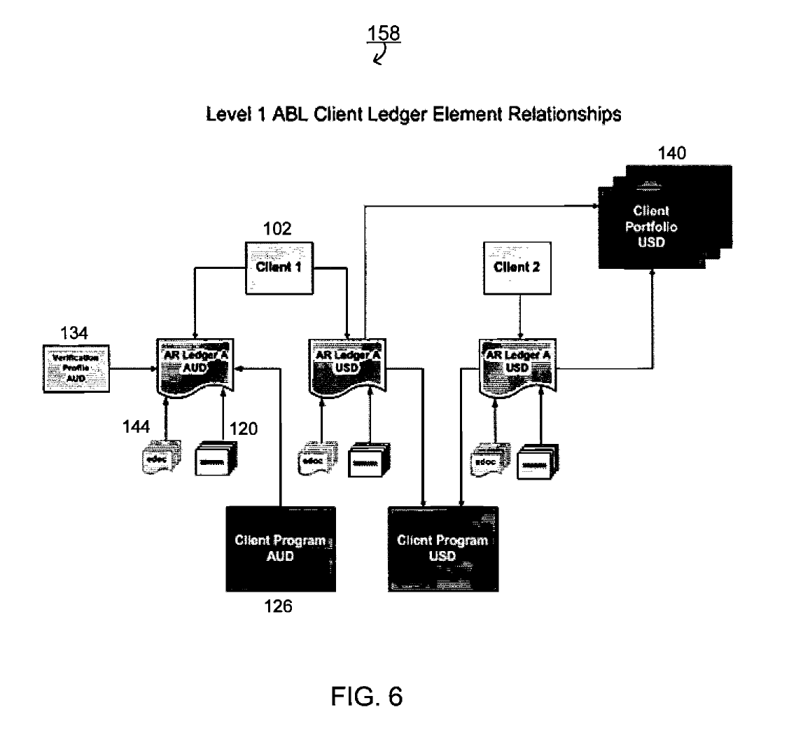

FIG. 6 is a diagram illustrating the ABL client ledger element relationships 158. Client AR ledgers 122 have elements for (1) verification profiles, (2) client programs, (3) electronic documents, (4) debtors, (5) client portfolios, and (6) clients.

The ABL application 116 enables the financial institution user to associate a verification profile 136 to a specific AR ledger 122. This provides the capability for the financial institution 108 to configure specific verification rules for that client's AR ledger 122. Verification rules assigned at the ledger level override verification rules assigned to the client program 126 to which the client's AR ledger 122 is associated.

The electronic documents 144 associated to a client's AR ledger 122 are either detail or summary documents. The ledger type selected by the financial institution 108 at the time of set-up determines the level of detail required.

Clients 102 having detailed AR ledger 122 must provide all accounts receivables details and can be reconciled either at a summary level or detailed level. Financial institutions 108 have a greater level of confidence when lending to clients 102 that provide detailed accounts receivables information. Detail ledgers offer a granular view of the clients 102 accounts receivable and, therefore, provide a more accurate picture of dilutions, payment trends and other key factors used when calculating the client's facility. Further details regarding the use of electronic documents 144 are provided below.

Summary clients 104 enter summary ledger data for each debtor 120. While not as accurate as a detailed clients ledger data, summary functionality provides a lending solution for clients 102 that are unable to provide detailed data.

A client 102 can belong to more that one portfolio via its ledger. This allows the financial institution 108 to associate the client's AR ledger 122 to any number of portfolios. In this manner the client 102 can be associated with any number other clients 102 (providing their ledgers are in the same currency) for the purpose of providing portfolio queries and management.

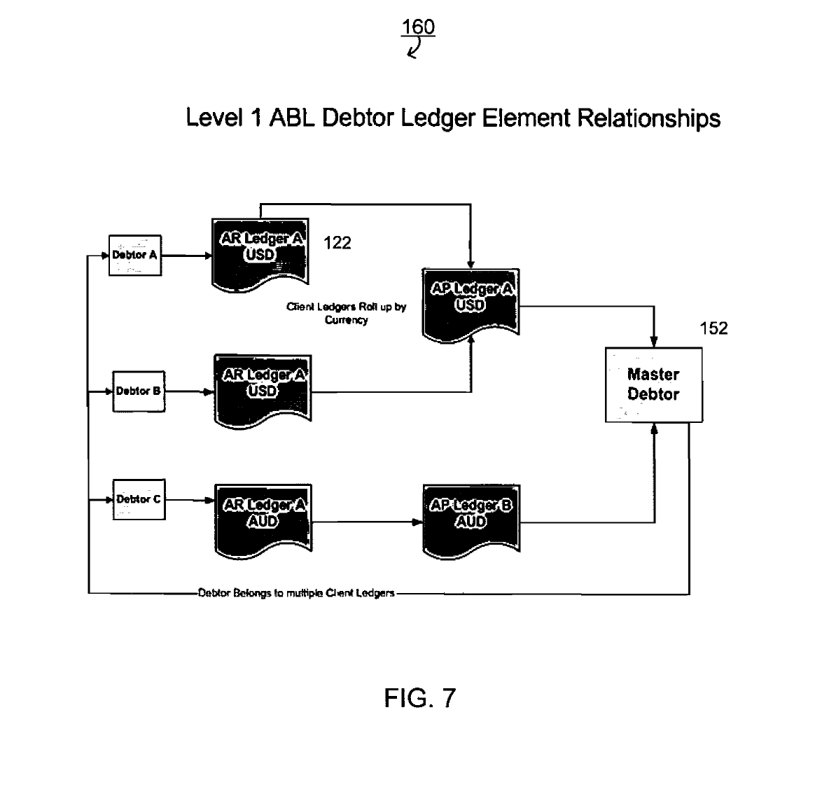

FIG. 7 is a diagram illustrating the ABL debtor ledger element relationships 160. Debtor AP ledgers 124 have elements for (1) client ledgers and (2) master debtor.

The client AR ledgers 122 include the ledgers to which that debtor 120 is associated. This association occurs via the master debtor 152 element. The debtor's AP ledger 124 is a summary ledger consisting of all account receivable data across all client AR ledger 122 having the same currency. Therefore, if a debtor 120 is associated to client AR ledger 122 having multiple currencies, the debtor 120 will have a summary accounts payable ledger for each currency.

The master debtor 152 indirectly associates all of a debtor's instances to their client's AR ledgers 122 for the purpose of viewing a consolidated list of currency specific ledgers across all clients 102.

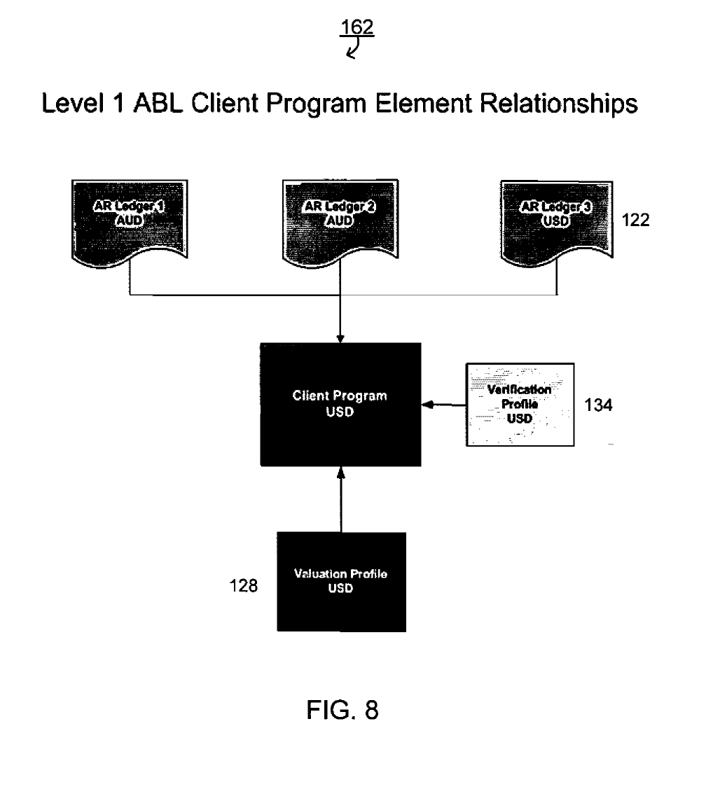

FIG. 8 is a diagram illustrating the ABL client program element relationships 162. Client programs 126 have elements for (1) verification profiles, (2) valuation profiles and (3) client ledgers.

A client program 126 has an associated verification profile 136. The verification profile 136 defines the specific verification rules for all clients 102 associated with the client program 126. Verification profiles 136 directly assigned to a client 102 belonging to a client program 126 take precedence over the verification profile 136 assigned to the client program 126.

Valuation profiles 128 assigned to the client program 126 apply to all client ledgers assigned to the client program 126. If the financial institution 108 desires a separate valuation profile 128 for any given client AR ledger 122, then the financial institution 108 establishes a separate client program 126 and moves the client AR ledger 122 to that client program 126.

The assignment of a client AR ledger 122 to a client program 126 is performed by editing the client AR ledger 122 and selecting the desired client program 126. A client AR ledger 122 can have a verification profile 136 assigned. For all cases where a specific verification profile 136 is assigned to a client AR ledger 122, the specific assignment will override the verification profile 136 assigned to the client program 126.

The valuation profile 128 tool assists the financial institution 108 in accurately determining the borrowing base for all clients 108. The valuation profile 128 consists of pricing profiles 130 and tier 134 parameters. Tier 134 parameters are configured by the financial institution 108 to calculate the borrowing base in such a way that it reflects the financial institution's appetite for risk and revenue. Once configured and activated, the valuation profile 128 parameters are used in the borrowing base calculation to value all of the client's debtors invoices. The tiers 134 are used to segregate debtors 120 into groups 138 based on their risk score. The tiers 134 determine how much of any one debtor's invoices can make up the client's 102 borrowing base.

The pricing profile 130 determines the rates and fees applied to the client's facility when creating a draw.

A valuation profile 128 is associated with a client program 126. Valuation profiles 128 are currency specific and preferably are not associated with a client programs 126 having a different currency. Valuation profiles 128 can be used in any number of client programs 126. They also allow for identification of all instances where client programs 126 are affected by modifications to a specific valuation profile 128.

Valuation profiles 128 having a status of “development” have the capability to run “what if?” scenarios. These scenarios enable the financial institution 108 to modify the development valuation profile 128 and, from the related client program tab, initiate a borrowing base calculation against any client program 126 associated with that valuation profile 128. The results are displayed back to the financial institution 108 on a results page that show the change in current available borrowing base and recalculated borrowing base for all clients AR ledgers 122 associated with the selected client program 126. Financial institutions 108 can then see the potential effects of their valuation profile 128 changes before they are implemented.

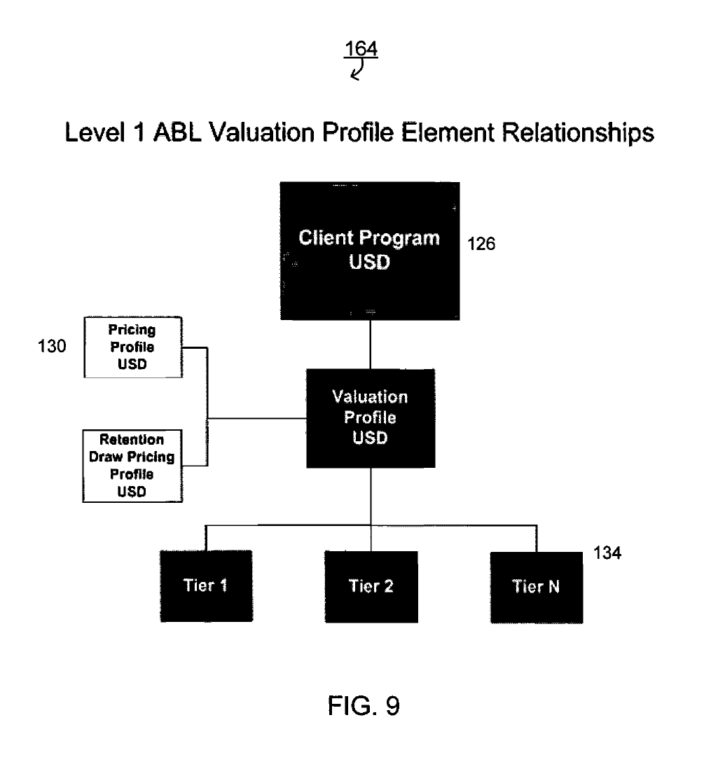

FIG. 9 is a diagram illustrating the ABL valuation profile element relationships 164. Valuation profiles 128 have elements for (1) client programs, (2) pricing profiles and (3) tiers.

A valuation profile 128 can be associated to any number of client programs 126. Preferably, the valuation profile 128 cannot be deactivated if it is associated to an active client program 126.

The pricing profile 130 provides the rates and fees that are associated with the valuation profile 128. A valuation profile 128 can have a new pricing profile 130 assigned. Preferably, the pricing profile 130 can not be deactivated if it is assigned to an active valuation profile 128.

The tiers established for the valuation profile 128 provide the criteria used in calculating the borrowing base. Preferably, pricing tiers are modifiable. Pricing tiers are established to value debtor's receivables in the AR ledger 122. The valuation profile 128 can have as many tiers 134 as the user 150 desires. Tiers 134 must be cross-referenced to a debtor 120 or multiple debtors. There can be any number of pricing tiers associated with a valuation profile 128. Tiers 134 provide the financial institution 108 with a flexible and granular method for valuing the borrowing base.

Accessed from the manage menu options, a user 150 with the appropriate role is able to create, fine tune (perform what-if scenarios before posting—making them available) and manage valuation profiles. The user 150 will typically be a credit manager or someone with credit responsibilities. Once the user 150 has posted a new valuation profile, it will appear in a table of available valuation profiles 128 and be seen as active.

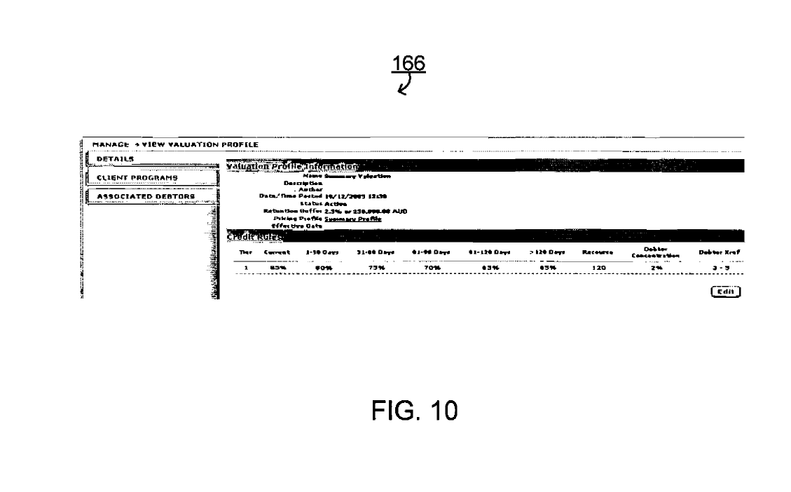

FIG. 10 is a screen image illustrating an example valuation profile 166 page. The valuation profile 128 contains three tabs for details, client programs 126 and associated debtors 120. Under the details tab, fields for (1) name, (2) description, (3) author, (4) date/time posted, (5) status, (6) retention buffer, (7) pricing profile and (8) effective date. The fields are shown in the section labeled ‘valuation profile information.’ The name of the profile is supplied by the financial institution 108. The description field provides detailed information regarding the valuation profile 128. The author is the user 150 that created and made the valuation profile 128 active. The date/time posted field provides the date and time the valuation profile 128 was made active. The status may be (a) development, (b) active or (c) inactive.

The development status corresponds to a user 150 fine tuning the profile, where the profile is not made available for association with a client program. While in development status, the profile cannot be associated with a client program 126.

An active valuation profile 128 is available from the list of available profiles and is ready for association with the client program 126.

An inactive valuation profile 128 cannot be associated with a client program 126. When a valuation profile 128 is set to inactive, the user is required to select another active profile to replace the inactive profile. A replacement active profile is selected for any client program 126 that has the inactive valuation profile 128 associated with it. It should be noted that a client program 126 cannot have an inactive valuation profile associated with it. However, any changes made to a profile once it is assigned will result in generation of another profile; the old client program 126 remains active and applies to any other client AR ledgers 122 associated with it. (The old client program will therefore remain unchanged against any other client AR ledger 122 associated with it, unless the user chooses to “replace all associated ledgers”. Preferably, the new client program 126 created does not take effect until the next business day.

The retention buffer is stored as both a percentage and an amount. These figures are used to determine the minimum retention amount. If the retention percentage is greater than the minimum retention amount after the borrowing base has been calculated, the borrowing base will be adjusted down to leave the required retention amount. To determine the minimum retention amount, the system will compare the two values and use the greater value.

The pricing profile 130 is the pricing profile 130 that applies to all draws, regardless of tier. The pricing profile 130 also applies to any retention draws.

The effective date controls when the active profile takes effect, e.g., next business day.

Also shown in FIG. 10 are valuation tiers under the section labeled ‘credit rules.’ Valuation tiers are established to value debtor's receivables in the AR ledger 122. The valuation profile 128 can have as many tiers 134 as the user desires. Tiers 134 are cross-referenced to a debtor 120 or to multiple debtors.

Aging columns are established to age the accounts receivable for valuation purposes. The user may set up any number of aging columns. The aging columns are presented showing from-to dates. For example, 0-30 (0 being today), 31-45, 46-60, 61-75, 76-90 and >90. The numbers represent the days. The system takes the AR ledger 122 and ages it into these columns. (It should be noted that the system ensures that the next tier added begin with next sequential number from the previous tier, thus preventing any gap between the numerical sequencing of tiers).

The aging values are the percentage of the summary value (ABL summary draw) or transaction (invoice) value within that aged column that the ABL system calculates as the borrowing base, for ABL, or as the amount paid—balance being retention in the case of ABL.

The maximum tenor (also “recourse days”) is the maximum number of days old that the summary amount or transaction (invoice) can be accepted into the valuation calculation. For example, if the tier 134 has a maximum tenor of 90 days and the accounts receivable debtor has summary value and/or transactions older than 90 days, these will be excluded from the valuation of the borrowing base.

Preferably, there is a default maximum tenor value stored at the AR ledger 122 level in the verification profile 136. The AR ledger 122 value is used as a default, with value in the valuation profile 128 overriding the AR ledger 122 default setting as necessary.

Additionally, there is a flag also set at the AR ledger 122 level to determine how the tenor is calculated. The tenor may be calculated either by invoice date or by month received date. For calculating by invoice date, the age of the invoice is calculated from the actual invoice, and then determination is made as to whether or not it falls within the maximum tenor. For calculating by month received date, for the purposes of the maximum tenor, the effective invoice date becomes the end of the month date of the invoice. For example, an invoice date of Jan. 1, 2005 becomes an effective date of Jan. 31, 2005).

The debtor 120 concentration is the maximum concentration by any one debtor 120 as a percentage of the total borrowing base or the trade being calculated. Once a debtor 120 reaches the concentration limit, the balance of the receivables value associated with the debtor 120 will be excluded from the calculation.

The client programs 126 is a list of client programs 126 that the valuation profile 128 is associated with. The table is shown as a tab (or menu item hyperlink).

The debtor cross reference is a group of debtors associated with that tier 134. They can be grouped by the user 150, or the user 150 can associate a debtor rating number. All debtors 120 with that rating will be included unless already in a specific tier 134. The user 150 assigns the risk score to each tier—or a range of risk scores as in the example profile below—or the user 150 selects specific debtors 120 to a tier 134. Specific debtors 120 are assigned to a tier 134 by direct association. The ABL system allows the financial institution user to search for a select a debtor 120 to specifically attach that debtor 120 to a tier 134.

Creating and Fine-Tuning a Valuation Profile

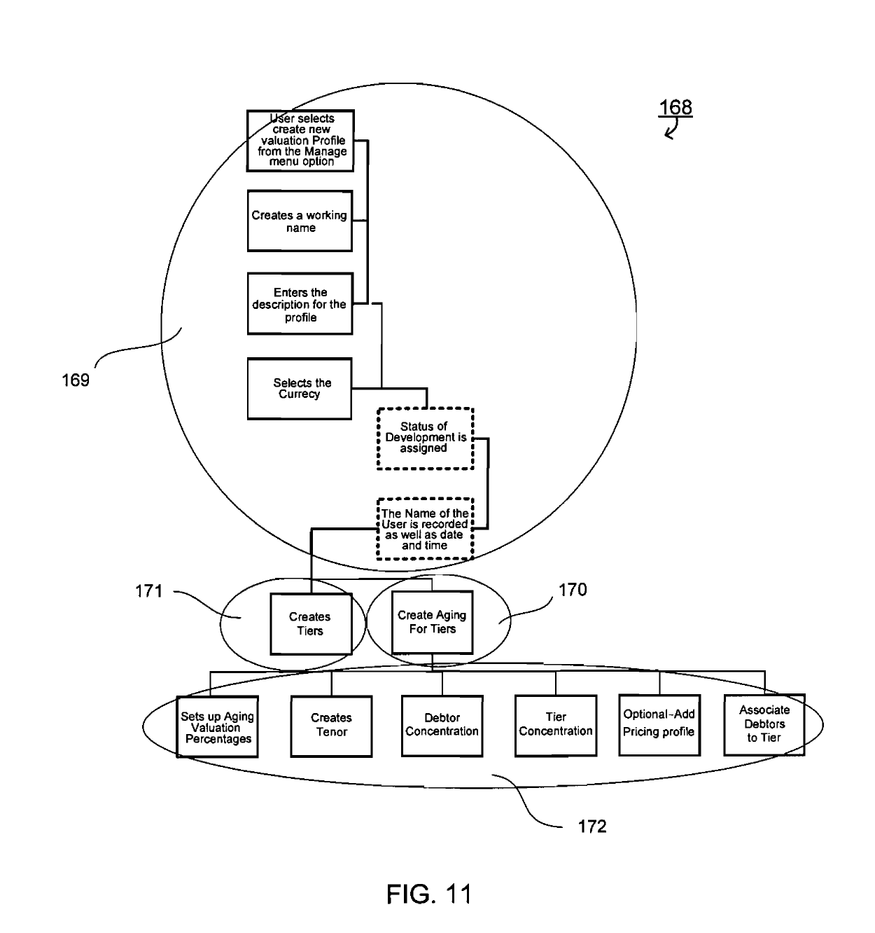

FIG. 11 is a diagram illustrating the steps for valuation profile creation 168. A user 150 may create a valuation profile 128, fine tune the valuation profile 128, and change the valuation profile 128 status to active. Fine-tuning of the valuation profile 128 is necessary to ensure that the right results are achieved when applied. The user 150 is able to select client's AR ledgers 122 or groups of client's ledgers to run the scenarios against. ABL scenarios are compared to the existing valuation of the selected client's AR ledgers 122.

The initial step 169 adds the valuation profile 128 and associated descriptive information. System captured data includes setting the profile to a development status and inserting the user name and date/time entered.

An optional step 170 allows the user 150 to configure any number of aging categories. This is optional since there are preset aging categories already configured.

Any number of tiers 134 may be configured by the user as shown with step 171.

Finally, once the tiers have been added, at step 172 the user 150 then enters the data into the tier parameters such as aging valuation percentages, creating tenor, debtor concentration, tier concentration, optional add pricing profile, associate debtors to tier, among others.

Once the user 150 has completed the steps required to create the valuation profile 128, the user 150 can then fine tune the values in the set-up under the development status.

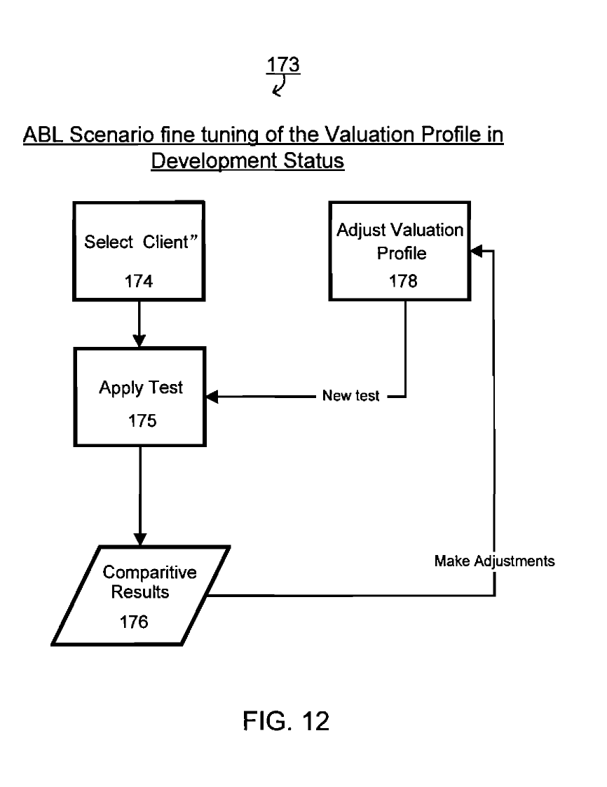

FIG. 12 is a diagram illustrating the steps for fine-tuning a valuation profile 173. The user 150 selects clients 174 to test the new valuation profile 128 against. The system checks the clients AR ledgers 122 and matches the ledgers based on currency. Next, the system applies the test 175 by testing the valuation profile against the currently selected ledgers and provides comparative results. Comparative results 176 compare the current borrowing base to the new valuation profile 128 being tested. Adjustments 178 are then made to the valuation profile and a new test begins. As each new test is completed, the results are recorded against the current borrowing base of the selected client's AR ledgers 122, as well as the results from prior tests. These results will continue to be recorded so long as the valuation profile 128 is in development status.

Users 150 with the role to create the valuation profile 128 are able to work with a valuation profile 128 once it is set up in development status. The user 150 selects clients 102 or groups 138 of clients AR ledgers 122 to perform “what if” scenarios. These scenarios use real data from the clients 102 selected but will not overwrite the active valuation profiles 128 assigned to the client program 126. The purpose of this “fine-tuning” functionality is for the user 150 to determine the optimal valuation based on their risk assessments against the client data, doing comparisons to the actual posted valuation profile 128.

Each fine-tuning pass will create a results table. The results table will show (1) the valuation by tier (currency value), (2) the valuation of the overall asset and (3) the retention percentage.

These results will be saved each time to a log, so that the user can compare results against each pass.

Once the user 150 has completed the fine-tuning, the status is changes to active. It should be noted that as long as the valuation profile 128 remains in development status, it may be deleted. However, one it is active, it can not be deleted, only made inactive.

Calculating Borrowing Base

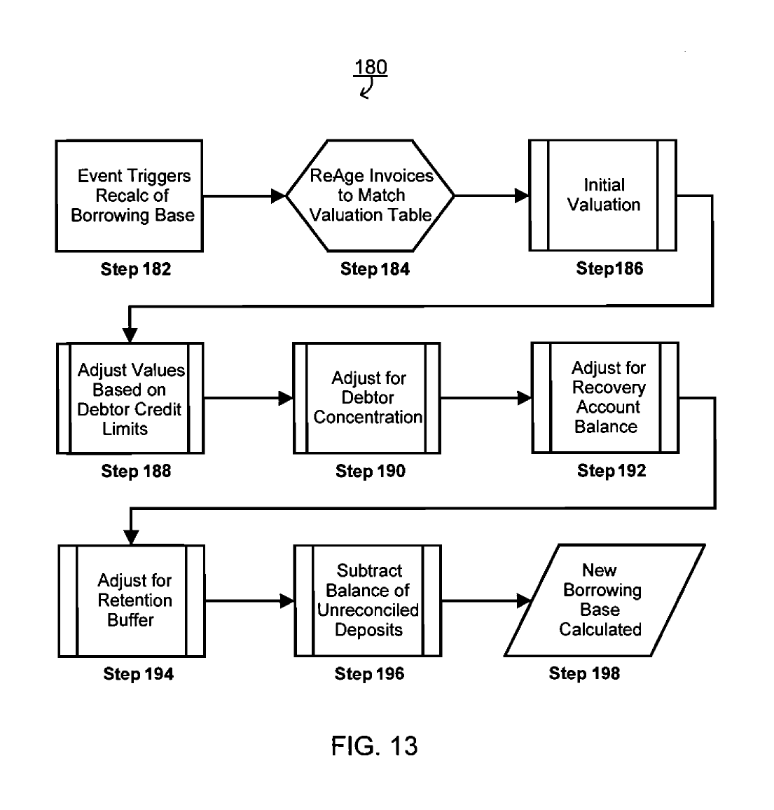

FIG. 13 is a diagram illustrating the steps for the borrowing base calculation process flow 180. The Valuation profiles 128 are used to value the total AR ledger 122 and calculate the borrowing base of each ledger.

Both ABL summary and detail are calculated based on the total owing by aging by debtor 120. The system calculates the borrowing base automatically at any time an event occurs that could affect the borrowing base amount. Events that trigger a recalculation of the borrowing base include (1) new e-documents received (invoices, journal entries, credit memos, cash applications), (2) any new draw is funded, (3) the valuation profile assigned to the ledger is modified, (4) the credit limit of one or more of the client's debtors is modified, (5) fees are charged to the client, (6) deposits are received, (7) deposits are reconciled, (8) client is refunded money from the recovery account, (9) reversals are performed and (10) daily recalculation for aging purposes.

The borrowing base calculation steps are (1) an event occurs that causes the borrowing base valuation to be recalculated, (2) re-age the ledger to fit the valuation aging columns and sort debtors into tiers, (3) first pass result—initial valuation (without any debtor credit limit or debtor adjustment), (4) check, calculate and adjust, if required, for debtor credit limits. If a valuation is above an individual debtor credit limit, then the value is reduced to match that credit limit, (5) calculate and adjust, if required, for debtor concentration, (6) calcaulate and adjust for the recovery account, (7) calculate and adjust, if required, for the retention buffer, (8) subtract balance of un-reconciled deposits and (9) result after debtor credit limit, debtor concentration checks, recovery account, retention buffer, and un-reconciled deposit adjustment(s), thus providing the new borrowing base.

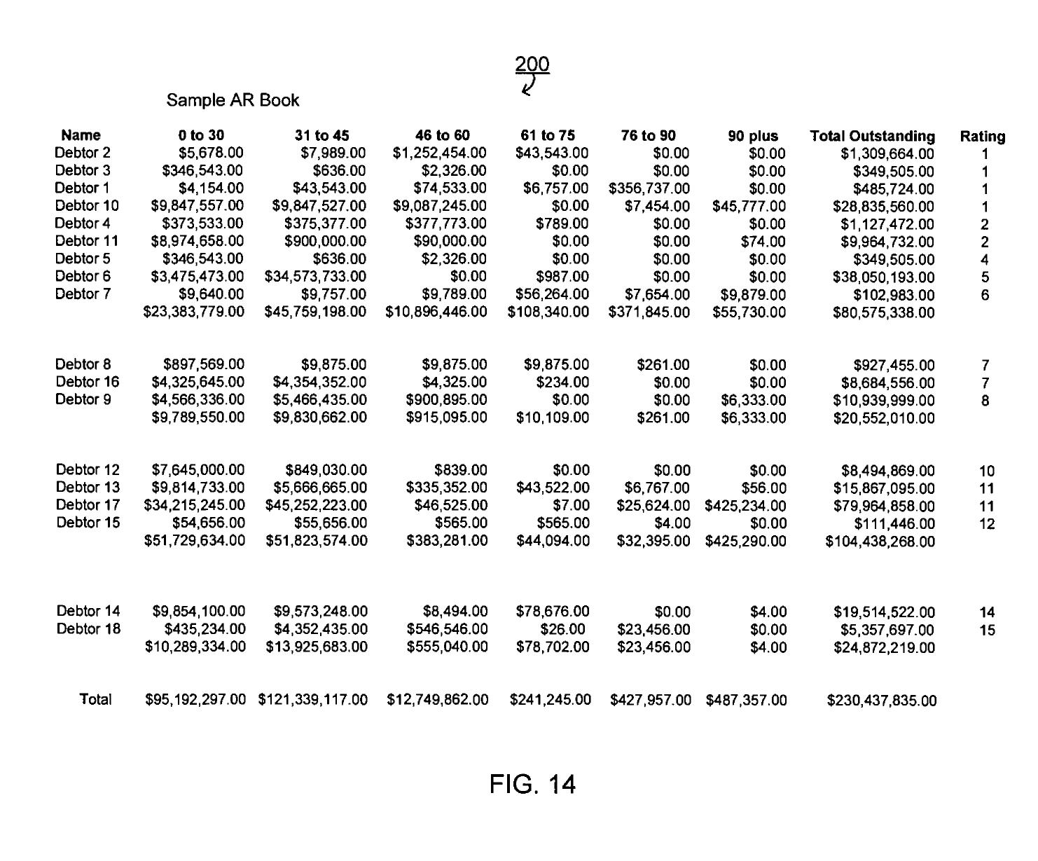

FIG. 14 is an example illustrating a sample client's accounts receivable book, debtors and their associated rating prior to valuing the borrowing base 200.

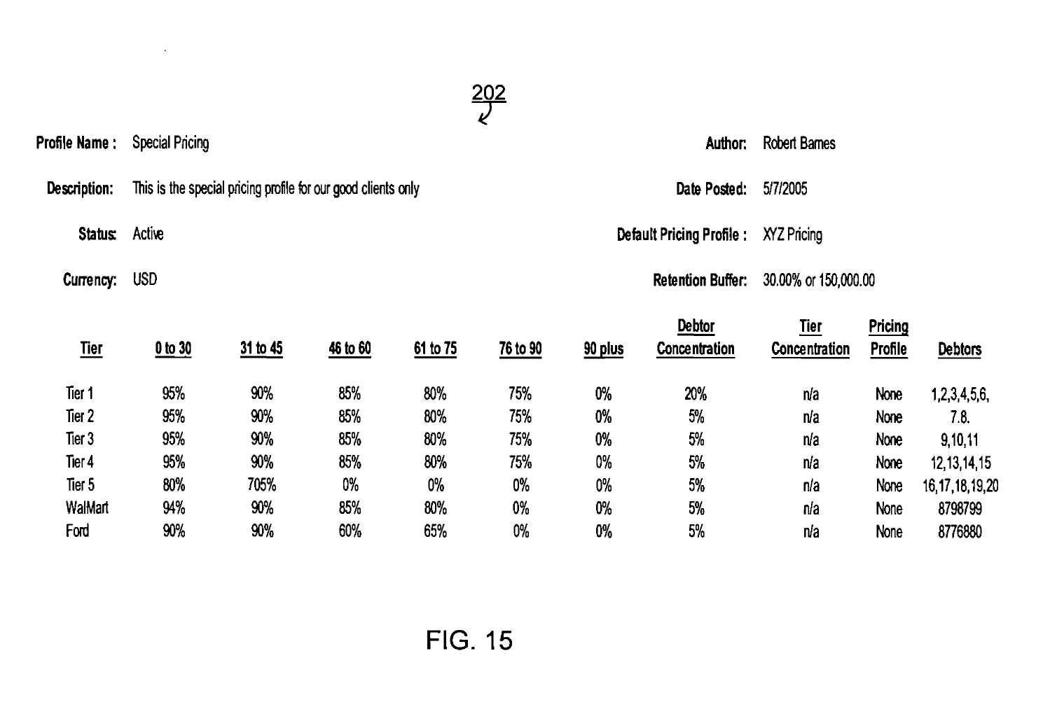

FIG. 15 is an example illustrating the use of a pricing profile to determine the borrowing base 202. It should be noted that the debtor column on the right represent the debtor ratings associated with the tier. For this example, tier 1 will age debtors with ratings 1 through 6.

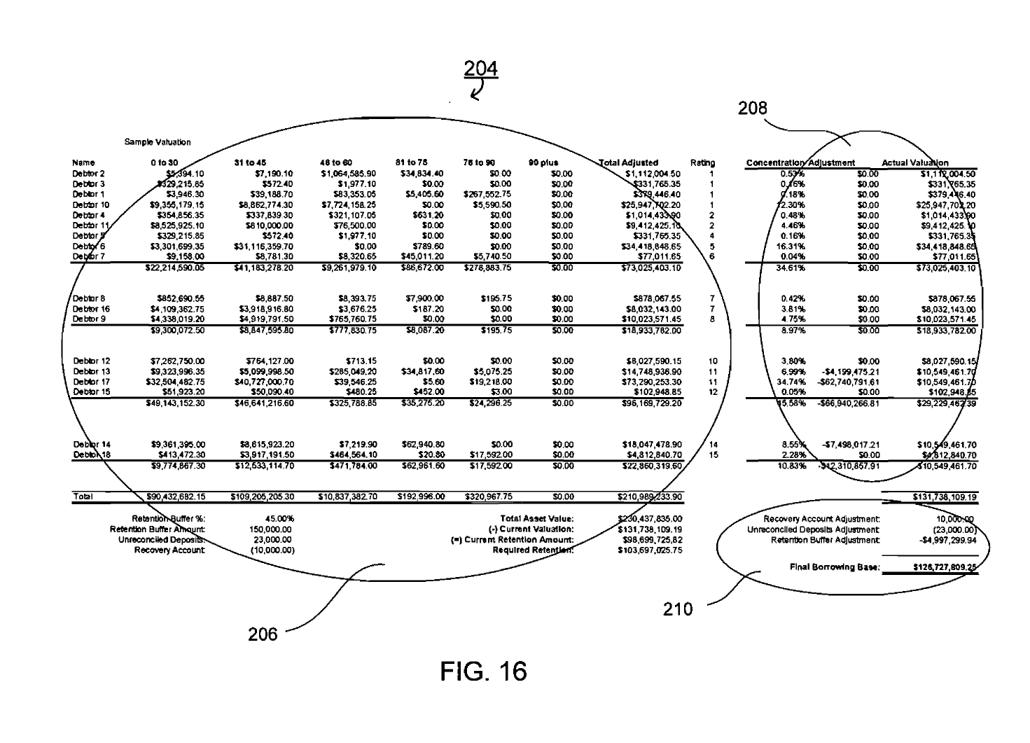

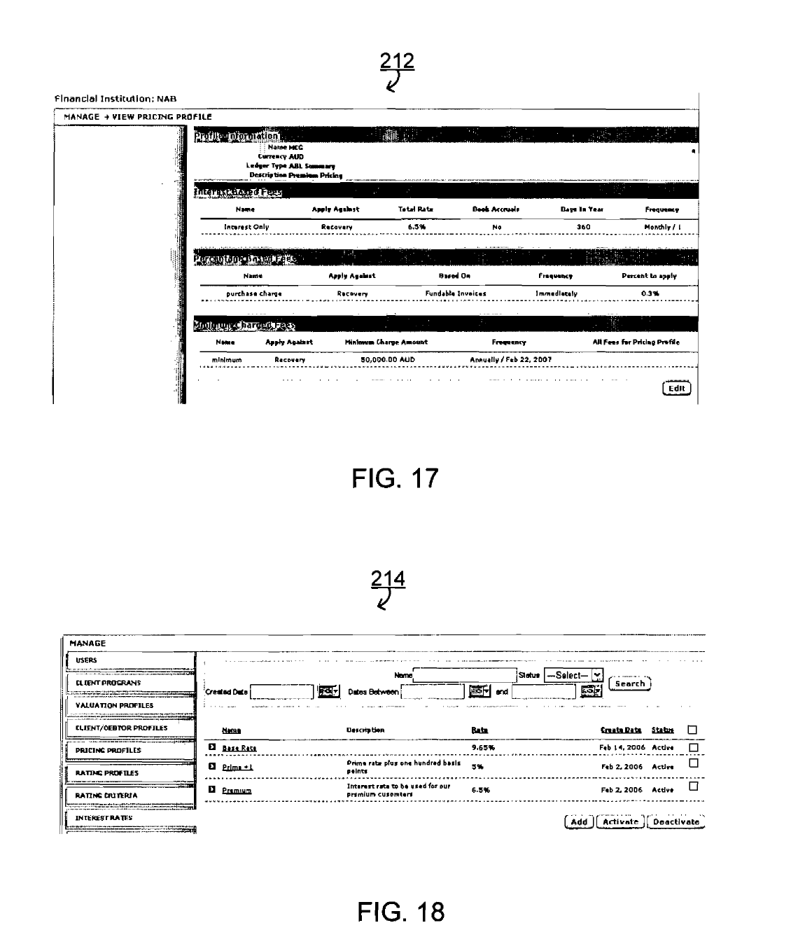

FIG. 16 is an example illustrating the results when applying a valuation profile against reorganized accounts receivable debtors 204. The data as selected in FIG. 17 below may be processed utilizing the steps discussed below and providing the results given in FIG. 16.

The material included within section 206 of FIG. 16 illustrates steps 1 through 3. In step 1, the debtors are organized into tiers based on their ratings (only tier 1-5 pertain). Then in step 2, each of the debtors invoice amounts are multiplied by the percentage value of the valuation profile aging column for those invoices in that tier/column combination leaving the amount accepted for that debtor. For example, debtor 2 in FIG. 14 had $5,678 in aging column 0 to 30 of tier 1. The percentage from FIG. 15 valuation profile tier 1 (0 to 30) is 95%. The resulting amount shown in FIG. 16 debtor 2 section 206 is $5,394.10. In step 3, the adjusted amounts are added to yield the total adjusted column on the far right of section 206.

Referring to section 208 in FIG. 16, step 4 illustrates that debtor credit limits reduce the amount any one debtor can occupy for that respective tier. For example, if debtor 2 had a credit limit of $5,000 then only the $5,000 would be accepted not the estimated $5,394.10. Next in step 5, the debtor concentration parameter (see FIG. 8) for each tier is applied against the total adjusted in FIG. 16 for each debtor to restrict the debtor to only contribute that percentage to the borrowing base. For example, in FIG. 16 section 208, the concentration percentage adjustment for debtor 17 of the overall borrowing base is 34.74%. However, the debtor concentration parameter (see FIG. 15) for that debtor is 5%. Therefore, the debtor 17 contribution is reduced by $62,740,791.61.

Steps 6 through 9 in section 210 illustrate the recovery account balance adjustment, the retention buffer adjustment and the un-reconciled deposits adjustment.

From FIG. 16, an example of the calculations show that the total asset value is $230,437,835.00. The initial valuation based on aging and debtor tier is $210,989,233.90. The amount adjusted for debtor credit limits and debtor concentration is $131,738,109.19. The amount adjusted for recovery account is $131,748,109.19 and the adjusted for retention buffer amount is $131,748,109.19. The amount adjusted for un-reconciled deposit balances is $126,727,809.25. Thus, the final borrowing base valuation, as shown at the bottom of section 210, is $126,727,809.25.

It should be noted that debtor concentration is calculated against the total accounts receivable valuation. It should further be noted that the system must also check the credit limit of the debtor 120 to see if the borrowing base amount based on that debtor 120 does not exceed the debtors credit limit. Should this be the case, the credit limit amount will apply for the portion of the ledger that is based on that debtor 120. For example if we assumed that debtor 14 had a credit limit of $11 million then the total value of the debtor before adjustment for concentration would have been $11 million and not $18 million as shown.

When calculating the available funds, the borrowing base is compared to the client's credit limit; the total amount of outstanding draws is subtracted from the lesser of the two amounts.

Pricing profiles provide the capability to configure the fees and interest applied to a client's ledger that is associated to a valuation profile.

FIG. 17 is a screen image of an example pricing profile page 212. The pricing profile page 212 contains the basic pricing profile 130 information including name, description, currency, profile type, ledger type and any additional fees as configured. The financial institution user manages the pricing profile 130 via a GUI provided by the ABL application 116.

Configuration of a pricing profile 130 includes (1) entering the pricing profile name, currency, ledger time (summary or detail) and description, and (2) adding fees. Fees are configurable and a financial institution 108 can add any number of fees to a pricing profile 130. Fee types may be interest base, per transaction, percentage based, minimum charged or minimum funding level.

The interest-based fee allows the financial institution 108 to charge the client 102 monthly interest against their total utilized funds.

Per transaction fees allow the financial institution 108 to charge a fixed amount per transaction, for various transaction types, including per draw, per invoice, etc. This allows the financial institution 108 to charge a certain amount per each invoice in the system, each debtor 120 for the client, etc. The financial institution 108 could also charge an amount per client ledger, for example. If the financial institution 108 desired to charge the client 102 a yearly fee, regardless of funding, they could set up a per transaction charge based on the client AR ledge 122, and set the frequency to be an annual charge.

Percentage-based fees allow the financial institution 108 to charge a specified percentage against a selected amount. This amount could be the draw amount per draw, or it could be based on an average or sum of values over a specified period of time.

Minimum charge fees allow the financial institution to determine a minimum charge that will be periodically. The financial institution 108 can use this to ensure that they receive a minimum amount of revenue for a given time period. At the end of the specified period, the ABL system calculates the total amount of revenue earned based on the fees configured in the list. If the total earned is less than the minimum required amount, the client is charged the difference.

Minimum funding level fees allow the financial institution 108 to charge the client a fee if the client 102 does not fund up to a certain amount over a specified period of time. This fee can be a percentage of the difference between the required funding level and the actual funding level or as a fixed amount.

Assigning Pricing Profiles to Valuation Profiles

Only one active default pricing profile is assigned to a valuation profile 128. A valuation may also have one active retention draw pricing profile assigned to it. The first step in assigning pricing profiles 130 to valuation profiles 128 is to locate the desired valuation profile 128 by first accessing the list of valuation profiles 128 from the “manage” option on the main menu (the search capability may be used if necessary). Selecting the valuation profile 128 name hyperlink allows for viewing the valuation profile 128 details. Then, selecting the edit button causes the valuation profile 128 to be displayed in edit mode. Next, selecting the pricing profile link will display the current pricing profile 130 assigned to the valuation profile 128 (if one exists). Next, the search capability is used to locate the desired pricing profile 130 (the pricing profile details may be viewed from this table). Finally, selecting the “associate” button will associate the pricing profile 130 to the valuation profile 128. It should be noted that changes as outlined above will preferably not take effect until the following day.

Maintaining Interest Rates

FIG. 18 is a screen image illustrating an example interest rates list page 214. Interest rates are maintained by financial institution users having the appropriate permissions. It should be noted that all interest rates are entered and displayed as percentages rather that basis points. The values are stored in the database as basis points. All screens that display basis points will display the values as percentages.

Interest rate lists may be accessed by selecting the manage option from the financial institution main menu. Selecting the interest rates option from the available management criteria causes a list of interest rates to be displayed. The search criteria at the top of the interest rates list is used to locate an interest rate. Search criteria options include name, current rate, status and create date, as well as a date range. The date range searches on all rates that were active within the selected range of dates. Finally, the desired search criteria may be entered and then the search button selected.

Interest rated may be added by selecting the add interest rate button to display the add interest rate page. The add interest rate functionality is essentially the same as the modify functionality.

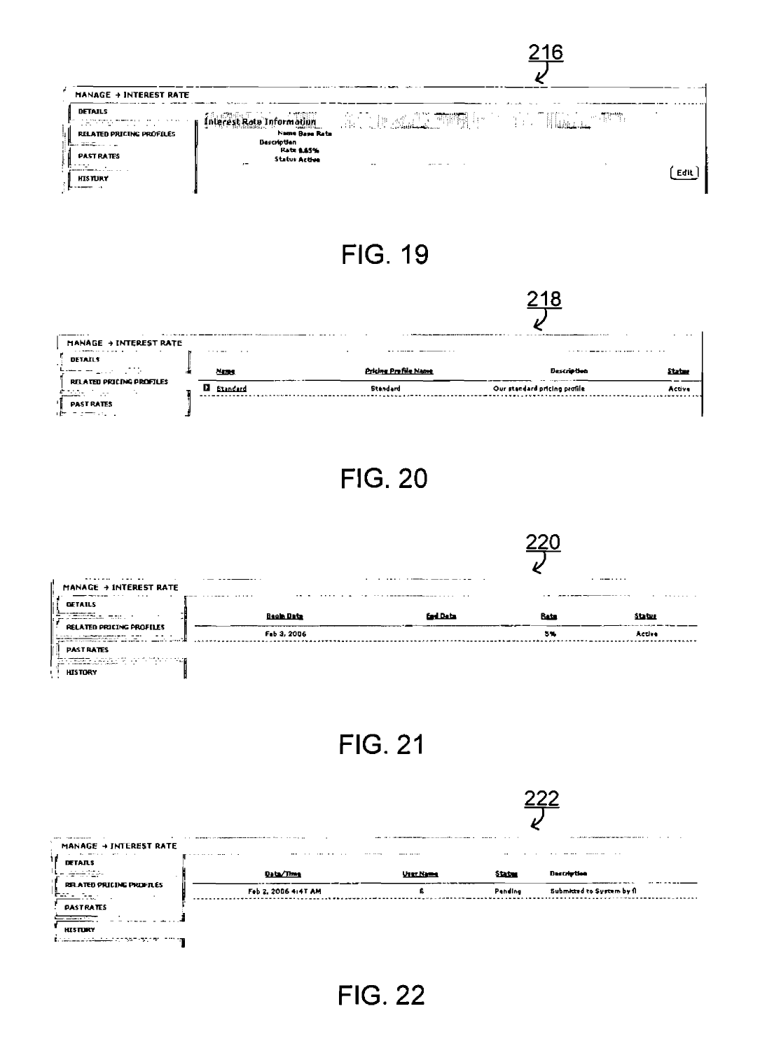

FIG. 19 is a screen image illustrating an example interest rate detail page 216. Selecting the underlined interest rate name causes the associated interest rate details to be displayed. Interest rates may be modified by selecting the edit button to display the edit interest rate page. The edit interest rate page has the same fields as the previously described view page.

FIG. 20 is a screen image illustrating an example related pricing profiles tab 218. All pricing profiles that currently use the interest rate are displayed.

FIG. 21 is a screen image illustrating an example interest rate detail—past rates tab 220. Past interest rates may be displayed.

FIG. 22 is a screen image illustrating an example interest rate detail—history tab 222. Changes to the interest rate record may be displayed.

The ABL system provides the ability to automatically update interest rates in the ABL system through an integration process with the financial institution's internal system.

Verification Profiles

FIG. 23 is a diagram illustrating the ABL verification profile element relationships 224. Verification profiles 128 have elements for client programs 126 and client AR ledgers 12.

Verification profiles 128 can be associated to any number of client programs 126 and client AR ledgers 122. Verification profiles 128 apply to client AR ledgers 122 associated with the client program 126 unless the client AR ledger 122 has a specific verification profile 128 assigned.

Verification profiles 128 can be associated to any number of client AR ledgers 122. Verification profiles 128 specifically assigned to a client AR ledger 122 override the verification profile 122 assigned to the client program 126.

Groups

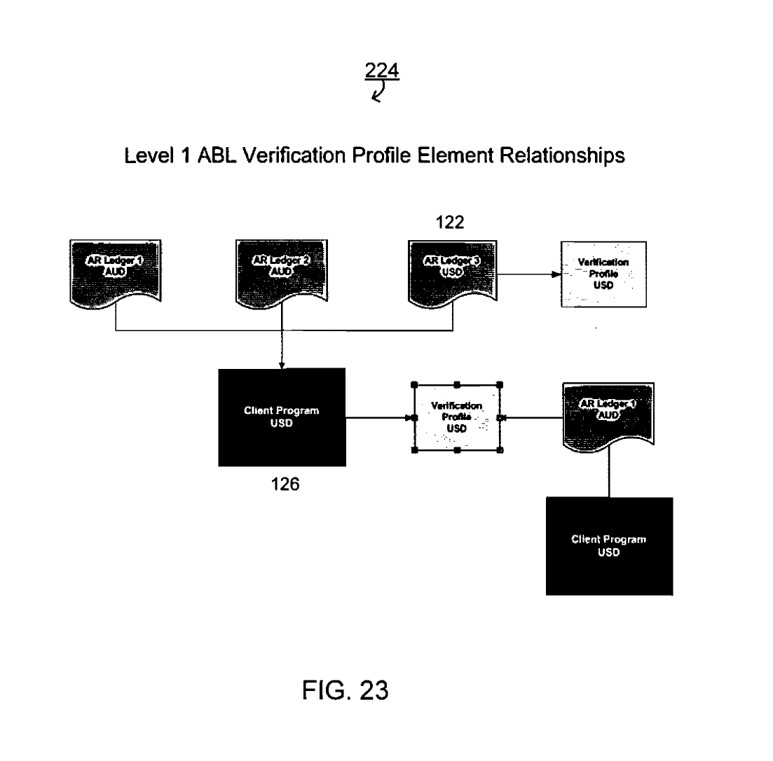

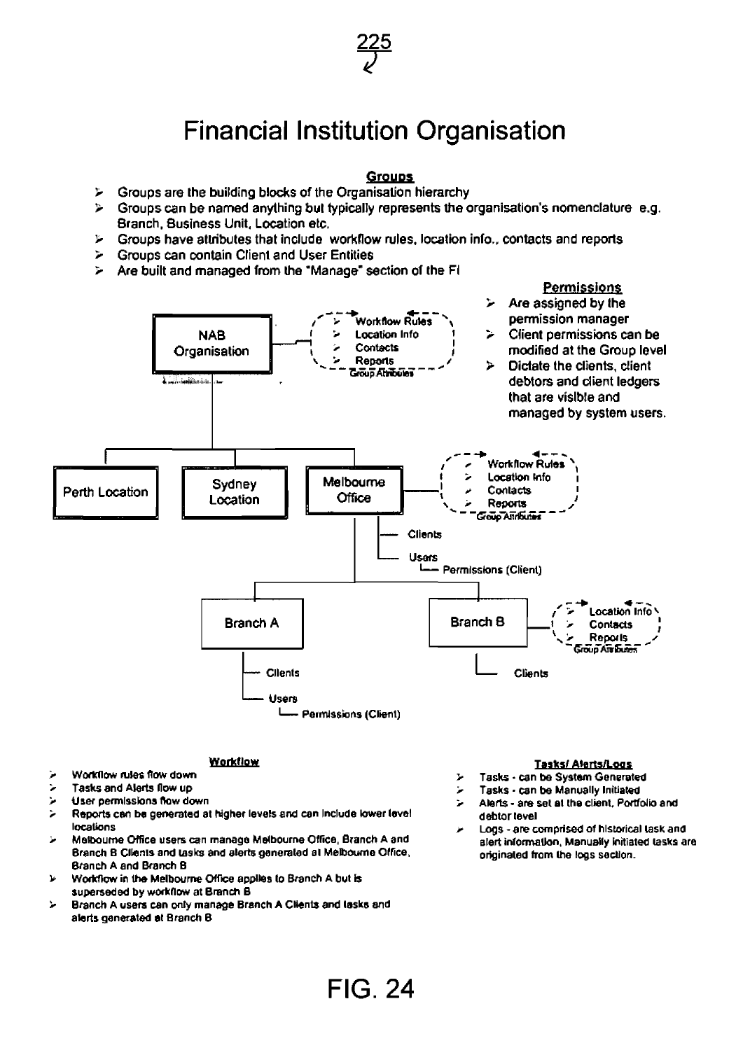

FIG. 24 is a diagram illustrating an example group hierarchy for a financial institution 225. The present system uses a group concept to manage the organizational hierarchy. Groups 138 can be used to represent locations, branches, and departments, among others, as necessary. The groups 138 can be used to represent a financial institution's organizational structure or any other structure necessary for assisting the organization in managing clients, user notifications and reporting. The diagram in FIG. 24 illustrates how groups 138 work to facilitate the organization, permissions, and tasks and alerts, associated with the financial institution.

Groups 138 are the building block of an organizational hierarchy and thus, clients 102 are organized into groups 138. When clients 102 are created they automatically belong to a group 138. Group names are not restricted but will typically represent the organizational nomenclature such as branch, business unit, and location, among others. Groups 138 have attributes that include workflow rules, location information, contacts and reports, among others. Groups 138 can contain client 102 and user 150 entities and are built and managed from the “manage” section of the financial institution. Clients 102 can also be moved between groups 138.

Client permissions are a set of permissions pertaining specifically to a client 102 and to the client's debtor. Client permissions are active at the group level. Client permissions are assigned by the permission manager and can be modified at the group level. Permissions determine the clients 102, client debtors 120 and client AR ledgers 122 that are visible and managed by system users.

Workflow rules and user permissions flow down, while tasks and alerts 148 flow up the hierarchy. Reports can be generated at higher levels and can include lower level locations. For example, in FIG. 24, the Melbourne office users can manage Melbourne office, branch A and branch B clients, and tasks and alerts 148 generated at the Melbourne office branch A and branch B. Further, workflow in the Melbourne office applies to branch A, but is superseded by workflow at branch B. Branch A users can only manage branch A clients and tasks and alerts 148 generated at branch B.

Unless a user 150 is specifically assigned to an alert or task 148, client tasks and alerts 148 go first to users 150 assigned to the client's assigned group 138. Groups 138 can also have sub-groups. If a task or alert 148 is issued within a group where no users have the necessary role to action the task or alert 148, then the task goes to the next higher group 138. This can repeat until the task has reached the top of the hierarchy.

Permissions flow downward in the hierarchy so that a user 150 with permission at a higher group level also has those same permissions for all lower groups 138. Reports can use the hierarchy as a roll up and organization mechanism.

Groups 138 can have location information. Workweeks and holidays can be set at the group level for workflow and will apply to subordinate groups if not set at those levels. Time zone and currency can be set at the group level. Daylight saving time is managed by the system and is accounted for by the central facilitator 106 application. For example, when the system recognizes a time zone change any group 138 having business hours assigned will immediately operate on the new time zone.

Modification to a hierarchy will not take affect until the next day. All changes to a hierarchy will be logged and are viewable. The capability to brand at the group level includes field sensitivity to regions. For example, a brand is for New Zealand and also controls the fields displayed.

A retry period can be set at the group level for tasks. The clients 102 and debtors 120 to which the financial institution user has visibility are based on the user's client permission and hierarchy assignment. Portfolios do not apply to groups 138 and are managed separately. Client permissions can be modified at the group level. Permissions pertaining to debtor add/disable/active, for example, are unrelated to client permission.

Tasks can be system generated and can be manually initiated. Alerts are set at the client, portfolio and debtor level. Logs contain historical task and alert information. Manually initiated tasks are originated from the logs section.

Groups 138 consist of attributes and entities and are maintained in the system via the financial institution program in the “manage” function. During the initial system set up, a single high level organizational group is added. It is not necessary to establish groups 138 beyond this level; however, most organizations prefer to use groups 138 to help them manage the system in line with their business unit organization and reporting. In addition, groups 138 help to manage tasks and alerts 148, workflow, and the organization of clients.

FIG. 25 is a screen image illustrating an example group list of the financial institution program 226. Groups 138 are maintained in the financial institution program from the “manage” function and only users 150 having the appropriate permissions may perform group management functions. Details may be viewed by selecting the group 138, client 102 or employee name, for example. Selecting a group icon will expand the view and show the employees and/or clients within that group 138. New clients or companies can be added by selecting the icon to the right of an item.

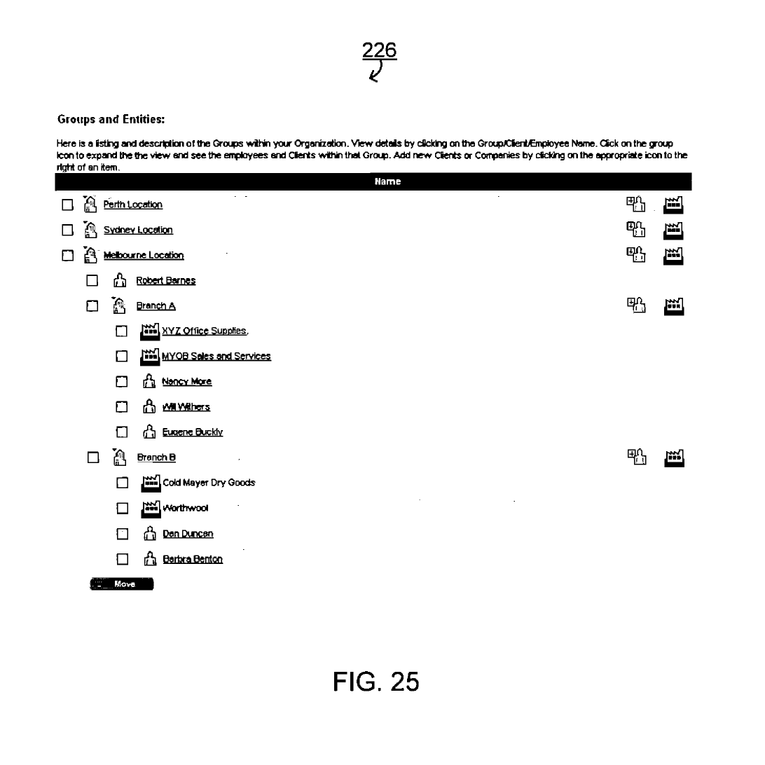

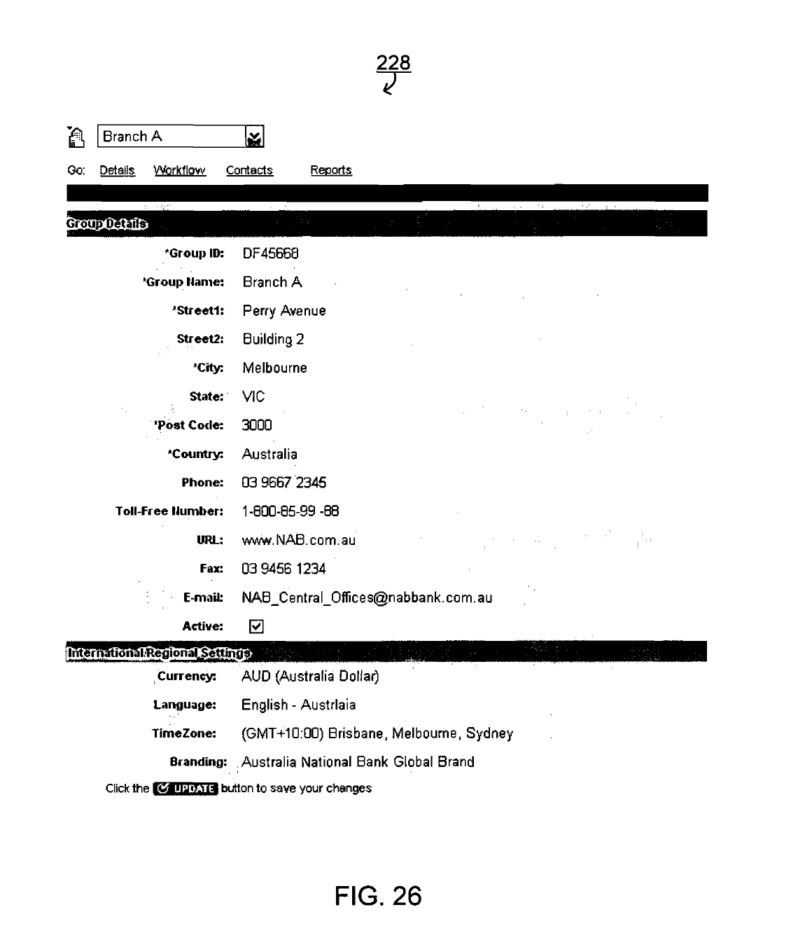

FIG. 26 is a screen image illustrating an example group details page 228. Group details may provide information such as a group ID, name, address information, telephone, URL, fax, email and whether the group is active, for example. International or regional settings such as currency, language, time zone and branding may also be provided. The group name is available in the pull-down menu at the top of the screen. Another group 138 may be selected from the pull-down menu.

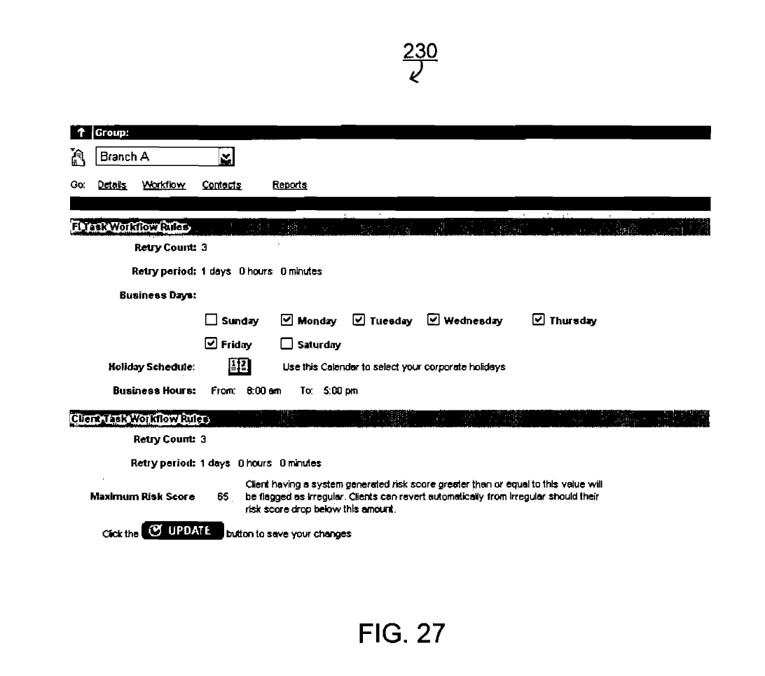

FIG. 27 is a screen image illustrating an example workflow page 230. Again, the group name is available in the pull-down menu at the top of the screen, and another group 138 may be selected from the pull-down menu. In the exemplary workflow screen, a financial institution task workflow rules section prescribes a retry count, retry period, defines business days and hours, and holiday schedule. Client task workflow rules such as, retry count, retry period, and maximum risk score are also provided. Of course, these workflow rules are exemplary only and could be varied in many ways to fit a particular workflow, as would be understood by one of skill in the art.

Group entities consist of users and clients. One can add or move entities by using the group manage interface provided in the financial institution program manage function.

Client permissions enable users to perform the necessary management functions used to maintain the client information, such as for example, ledgers, debtors, and client details, among others. Users with client permission can, therefore, perform those permissions for all clients 102 associated with the group 138 to which they belong.

Portfolios (Client and Debtor)

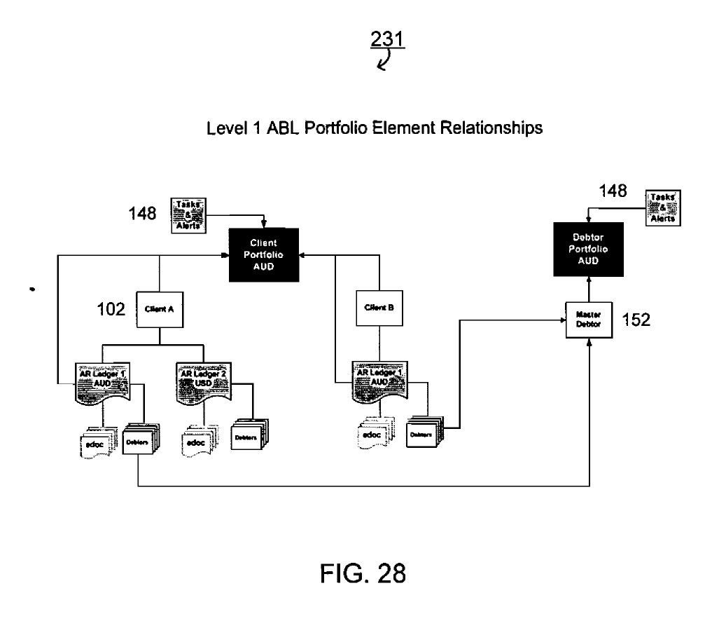

FIG. 28 is a diagram illustrating the ABL client/debtor portfolio element relationships 231. Portfolios may be either client or debtor type. A client portfolio 140 has elements for (1) clients and (2) client tasks and alerts. A debtor portfolio 142 has elements for (1) master debtors and (2) debtor tasks and alerts.

The financial institution user builds client portfolios 140 by associating clients 102 to the portfolio using the user interface. The financial institution user can build any number of portfolios. Portfolios are currency specific; the client 102 must have a ledger in the same currency as the portfolio before they can be associated. Clients 102 may belong to any number of portfolios. The portfolio has a variety of queries that can be performed against the client's ledger. The ability for the financial institution 108 to configure portfolios is a powerful tool in evaluating the risk and borrowing base lending opportunities for the clients 102 in the selected portfolio. For example, the financial institution 108 may place all clients 102 in a given industry into the same portfolio. In this way the financial institution 108 can evaluate the strength or risk of the selected industry in relation to future lending opportunities.

The financial institution 108 has a wide variety of tasks and alerts that can be configured at the portfolio. This enables the financial institution 108 to set watches across a number of clients instead of just one single client.

The financial institution user builds debtor portfolios by associating debtors 120 to the portfolio using the user interface. The financial institution user can build any number of portfolios. Portfolios are currency specific; therefore, the debtor 120 belongs to a client AR ledger 122 in the same currency as the portfolio in order to “associated.” Debtors 120 belong to any number of portfolios. The portfolio has a variety of queries that can be performed. The ability for the financial institution 108 to configure portfolios is useful in evaluating the risk and borrowing base lending opportunities for the debtors 120 belonging to the selected portfolio. For example, the financial institution 108 may place all debtors 120 in a given industry into the same portfolio. In this way the financial institution 108 can evaluate the strength or risk of the selected industry in relation to future lending opportunities for those debtors.

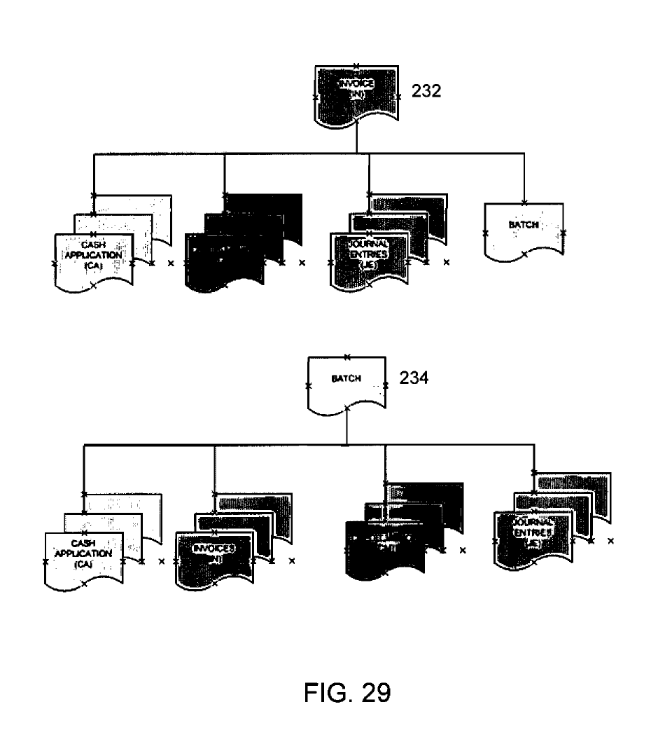

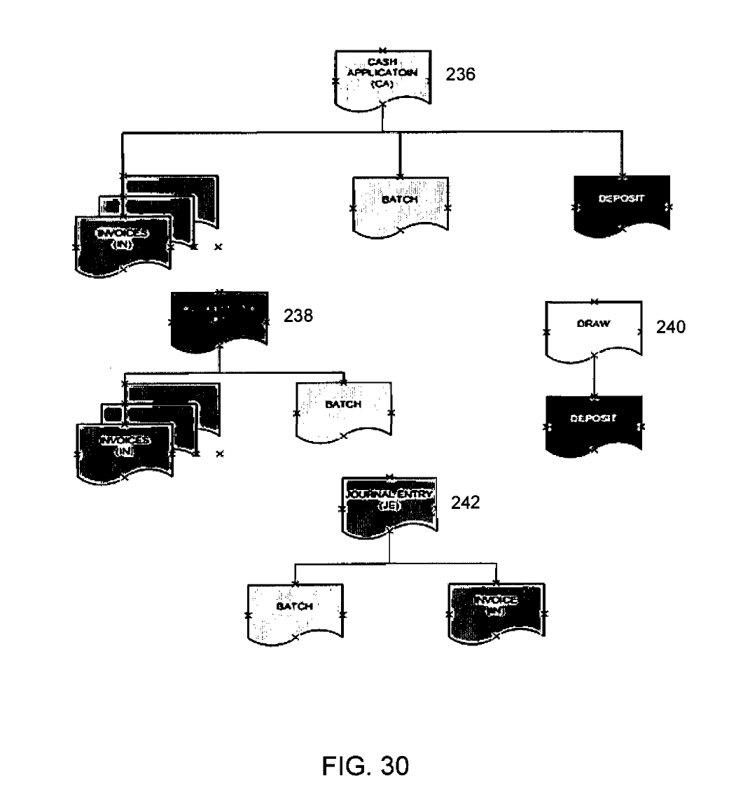

FIG. 29 and FIG. 30 are diagrams illustrating the ABL application electronic documents. Electronic documents 144 are building blocks of the ABL Application. Electronic documents 144 provide the capability for system users to view document details, document history, and link to related documents. The two primary users of the system are clients 102 and financial institutions 108. The view of each user may differ depending upon the pertinent data for that user type. Electronic documents 144 may include invoices, batches, cash applications, credit memos, draws and journal entries.

An invoice 232, as in FIG. 29, could include cash applications, credit memos, journal entries or a batch. A batch 234 could include cash applications, invoices, credit memos or journal entries.

A cash application 236, as in FIG. 30, could include invoices, a batch and a deposit. A credit memo 238 could include invoices and a batch. A draw 240 could include a deposit. A journal entry 242 could include a batch and an invoice.

FIG. 31 is a screen image illustrating an example draw page 246. Draws are part of the ABL process, and are typically submitted by the client 102 using the client interface. However, they can be submitted by financial institutions 108 using the financial institution interface.

There are several rules for submitting a draw. (1) The draw must be approved by the financial institution 108. Work flow dictates parties notified for approval. (2) The draw may be automatically approved if system defined automatic approval criteria are met. (3) When a draw is approved, it reduces the available funds and increases the amount utilized. (4) When deposits are paid into the clients account, the deposits are applied against the oldest draw first. (5) The status of a draw may be submitted, approved, closed, cancelled, partial pay or rejected. (6) From the deposits tab, users can link to and view the deposit details. (7) From the history tab, users can view draw history information such as date, time, and by whom the draw was submitted, and may see each status changed.

Submitted status indicates that a client 102 has made a draw request. Approved status indicates that the financial institution 108 has approved the draw request. Closed status indicates that the draw is fully paid and is therefore closed. Canceled status indicates that the draw has been canceled by the financial institution 108 or the client 102. Partial pay status indicates that one or more deposits has been made against the draw, but that the draw is still not closed. Rejected status indicates that the financial institution 108 or system has rejected the draw request.

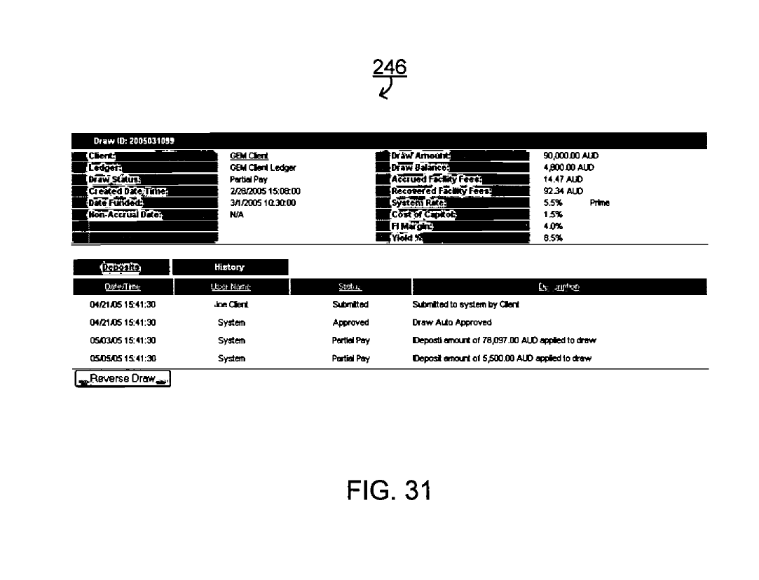

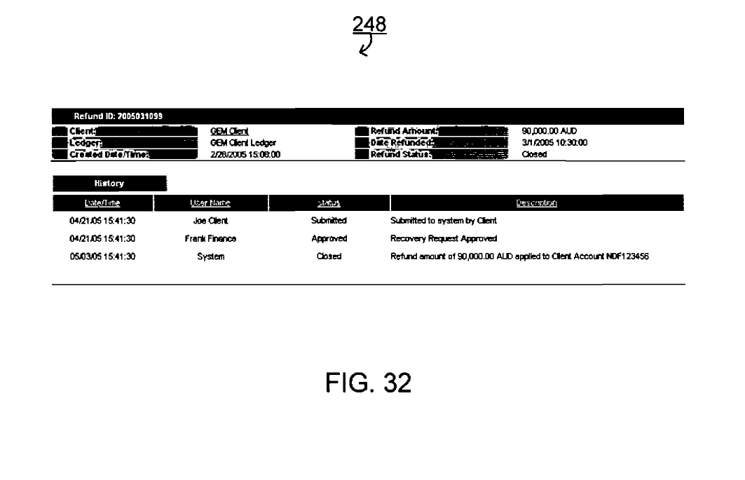

FIG. 32 is a screen image illustrating an example recovery refund page 248. Recovery refunds 248 are part of the reserve account processing and allow clients 102 to withdraw excess funds from the recovery account and to place them into their working capital account. Recovery refunds 248 are typically submitted by the client 102 using the client interface; however, they can be submitted by financial institution 108 using the financial institution 108 interface. There are several rules for submitting a recovery refund 248. The recovery refund 248 must be approved by the financial institution 108. Work flow dictates parties notified for approval. (2) The recovery refund 248 may be automatically approved if system defined automatic approval criteria are met. (3) When a recovery refund 248 is approved, it will reduce the recovery account balance. (4) The status of a recovery refund 248 may be submitted, approved, closed, canceled or rejected. (5) From the reserve account, users can link to and view a list of recovery refunds 248. (6) From the history tab, users can view recovery refund history information such as date, time and by whom the recovery refund 248 was submitted and may see each status change.

Submitted status indicates that a client 102 or financial institution 108 has made a recovery refund 148. Approved status indicates that the financial institution 108 has approved the recovery refund 248. Closed status indicates that the recovery refund 248 has been completed and is therefore closed. Canceled status indicates that the recovery refund 248 has been canceled by the financial institution 108 or client 102. A recovery refund 248 may be canceled using the reversal button. Rejected status indicates that the financial institution 108 or the ABL system has rejected the recovery refund 248.

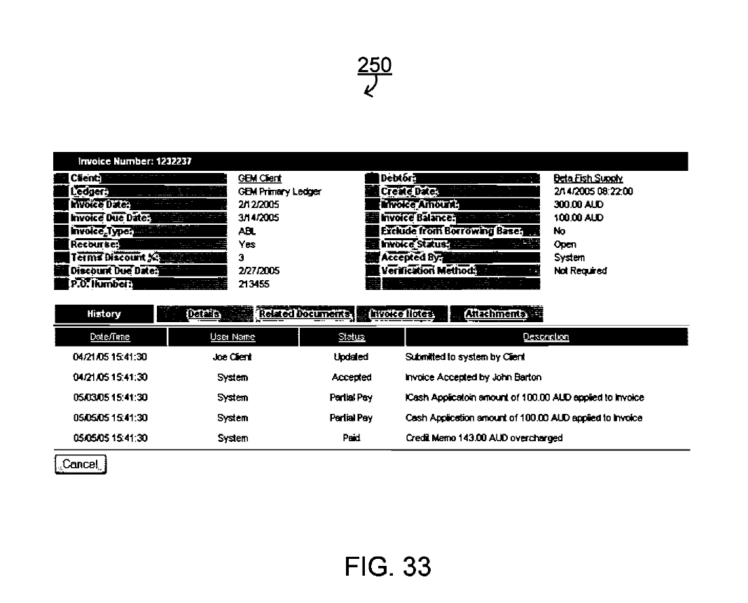

FIG. 33 is a screen image illustrating an example invoice page 250. The invoice is the primary document within the ABL system. It should be noted that for an integrated client, the invoice represents the open item on the accounts receivable/debtors ledger. Invoices can be (1) integrated directly from the client AR ledger 122, (2) file uploaded by the client 102 or financial institution 108 or (3) directly entered into the system by the client 102 or financial institution 108. The client's debtor 120 must be in the system and validated before invoices can be applied to a borrowing base or accepted into the asset base.

ABL invoices may have a status of open or closed. An open invoice may have sub-status of open/uploaded, open/error, open/accepted or open/partial pay. An open/uploaded sub-status indicates that invoices have uploaded to the central facilitator 106 and applies for integrated invoices and file upload invoices. An open/error sub-status indicates that an invoice has an error, such as for example, a debtor not in the system or an invoice date not within an accounting period. If integrated, then error handling is handled by the central facilitator data collection support team. An open/accepted sub-status indicates that an invoice has been added to the system, though it may not necessarily be part of the borrowing base. An open/partial pay sub-status indicates that a payment, journal entry or credit memo has been partially applied.

A closed invoice may have sub-status of closed/fully paid, closed/rejected or closed/canceled. A closed/fully paid sub-status indicates that an invoice has been closed due to full payment, though journal entries and credit memos may also apply. A closed/rejected sub-status indicates that an invoice is not allowed in the system, and may have been directly rejected or did not pass various requirements, such as, for example, amount currency, among others. A closed/canceled invoice has been canceled.

Each invoice has a related documents tab allowing users to view related documents, such as for example, credit memos and journal entries, among others. Invoices may be paid by one or more payments. Invoices may be charged back if it exceeds the charge back date for that client/debtor criteria. Invoices can be adjusted via journal entries positively or negatively. Invoices may have one or more credit memos applied.

A history tab displays all relevant events that have happened to the invoice 250, such as the date and time entered into the system, and how the invoice was entered (direct, import), among others. The system may apply payments both directly and automated, and also for credit memos and journal entries as well. Invoices may have attachments, and can be canceled only if all associated e-documents have been reversed or canceled.

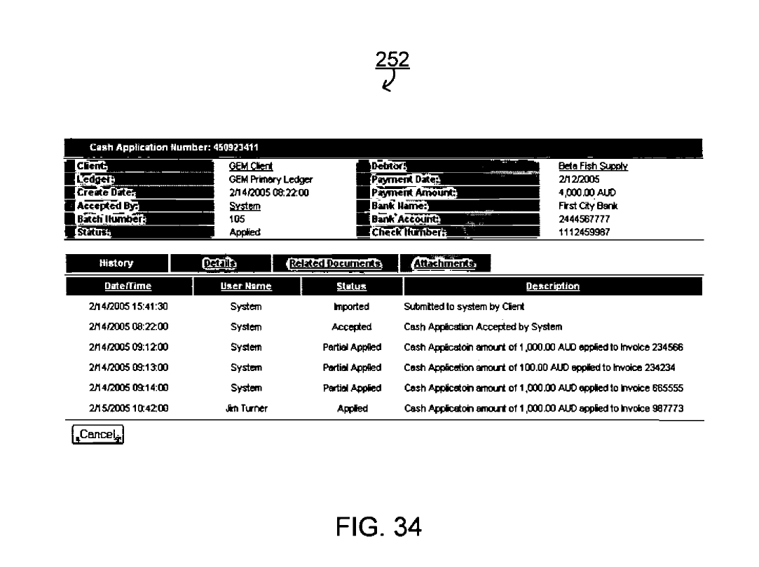

FIG. 34 is a screen image illustrating an example cash application page 252. The cash application page 252 is similar to the invoice page and has similar functionality for applying cash into the system.

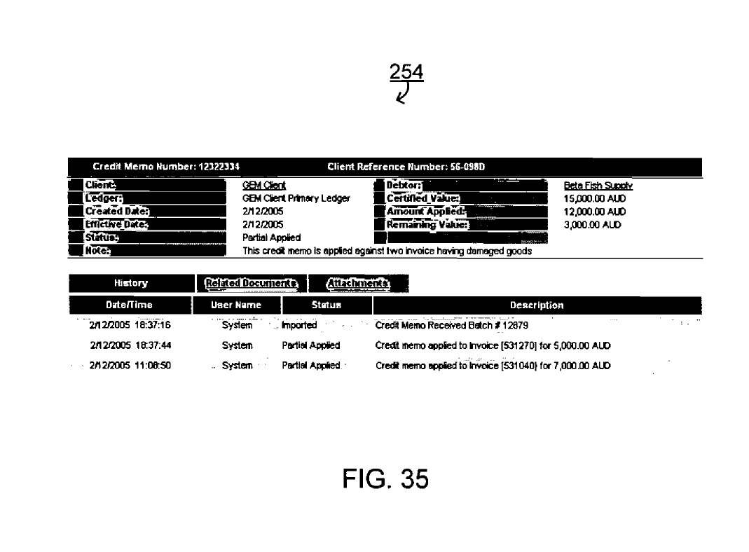

FIG. 35 is a screen image illustrating an example credit memo 254 page. Credit memos 254 are a method for clients to apply credits that their debtors have taken against invoices submitted to the ABL system. Credit memos 254 may apply to an individual invoice or to multiple invoices.

The credit memos 254 page contain a related document tab containing a list of one or more invoices to which the credit memo 254 was applied, and a hyperlink to view the invoice details. A history tab provides access to a list of historical events that have occurred to the credit memo 254, such as date, time and invoice number, and amount of credit memo 254 applied to that particular invoice. Attachment capability provides a way for the user to attach a related document in electronic form such as an invoice of damaged goods report. A note field provides a mechanism whereby the client may enter a note related to the credit memo 254.

Credit memos 254 may have status of uploaded, applied, partial applied, canceled or error. Uploaded status indicates that the credit memos 254 have been uploaded to the system. Applied status indicated that the credit memo(s) have been fully applied against one or more invoices 250. Partial applied status indicates that the credit memos 254 have been partially applied against one or more invoices 250. Canceled status indicates that the credit memo(s) 254 have been canceled out of the system, such as by a client via a journal entry, for example. Error status indicates that the credit memo(s) 254 contain an error, such as an invalid debtor or client number, for example.

Credit memos 254 may be input directly or uploaded into the system. Further, credit memos 254 may have attachments, and can be modified by a journal entry.

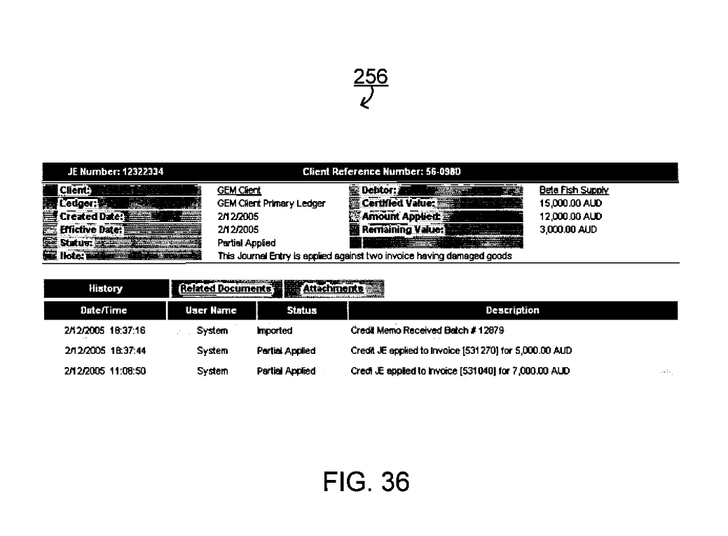

FIG. 36 is a screen image illustrating an example journal entry 256 page. Journal entries 256 allow for the adjustment of invoices. They may add to or reduce the amount of the invoice 250. Journal entries 256 are submitted by the client 102 either directly or uploaded, and may be either positive or negative amounts. Journal entries 256 may be applied against one or more invoices.

Journal entries 256 contain a history tab for displaying historical events associated with the journal entry 256, such as, when uploaded into the system, and how or when applied to invoices, among others. A related documents tab provides for displaying a list of all invoices to which the journal entry 256 was applied and a hyperlink to view the invoice details. A description field may optionally be used by the client for descriptive purposes. An attachment provides a mechanism for the user to attach a related document in electronic form such as an invoice of damaged goods report. The note field is provide for adding information relating to the purpose of the journal entry.

Journal entries 256 have status of uploaded, applied, partially applied, canceled and error. Uploaded status indicates the journal entry 256 has been uploaded into the system. Applied status indicates the journal entry 256 has been fully applied to related invoices. Partially applied status indicates that the journal entry 256 has only been partially applied to related invoices. Canceled status indicates that the journal entry 256 has been cancelled out of the system, such as canceled by a client, for example. Error status indicates the journal entry 256 contains an error, such as an invalid debtor or client number, for example.

Journal entries 256 may have attachments.

The status of the journal entry 256 is changes to “canceled” when the full amount of the journal entry 256 has been reduced to zero.

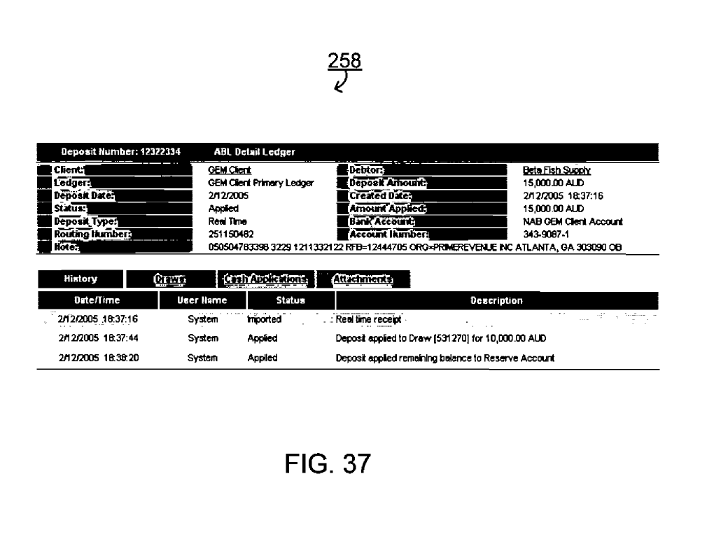

FIG. 37 is a screen image illustrating an example deposit 258 page. Deposits 258 are funds paid to the bank by the client or a clients debtor. Debtor deposits are typically made for the purpose of paying the client for invoices due. Deposits 258 are typically real time; however, the system allows for processing of batch deposits.

Deposits 258 are submitted by the financial institution either directly via system integration or uploaded in a batch. Deposits 258 apply against draws, and apply against oldest draws first.

A deposit 258 includes header information containing the client, debtor and client bank account to which the deposit 258 is made. A history tab provides for displaying all historical events associated with the deposit 258, such as when the deposit 258 was uploaded or passed into the system and how or when the deposit 258 was applied to invoices, for example. A related draws tab provides for displaying a list of all draws to which the deposit 258 was applied and a hyperlink to view the invoice details. A related cash applications tab provides for displaying a list of all cash applications to which the deposit 258 has been applied. A hyperlink is provided to view the associated cash applications. Another hyperlink associates cash applications with the draw. An optional description field may be used for descriptive purposes. The attachment option provide a mechanism for the user to attach a related document in electronic form such as, for example, a list of invoices that were paid as part of the deposit 258. The attachment option is available only in batch input. For deposit type, valid values are “batch” or “real time.”

Deposits 258 have status of uploaded, pending—auto match, pending—other, applied—auto match and applied—manual match. Uploaded status indicates that the deposit 258 has been uploaded into the system and applies for batch only. Pending—auto match indicates that the deposit 258 requires client review and approval. Pending—other indicates that the deposit 258 requires review and approval. Applied—auto match indicates that the deposit 258 has been fully applied to all related cash applications. Applied—manual match indicates that the deposit 258 has been fully applied to all related cash applications.

Deposits 258 may have attachments. The financial institution's banking system can issue a command to the ABL system to reverse a deposit. Detailed and summary clients having the correct permissions assigned have the ability to mark the deposit as non-funded cash without cash applications. (The financial institution would need to review and approve such action). Detailed and summary clients having the correct permissions assigned also may mark deposit as required to pay down draws without cash applications. A 100 percent deposit would pay down draws.

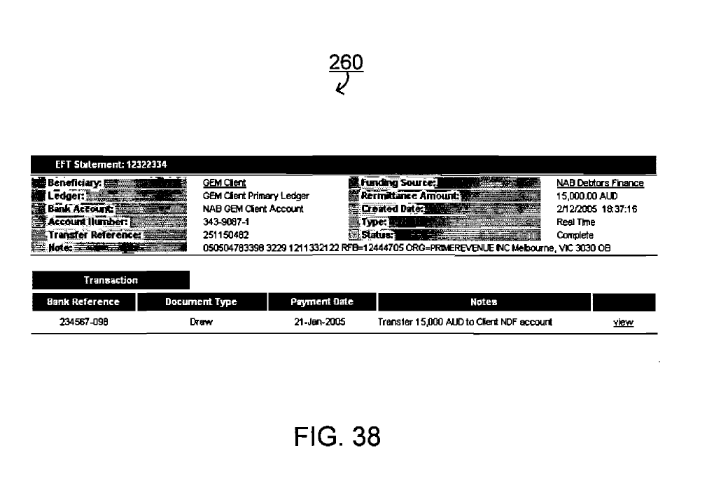

FIG. 38 is a screen image illustrating an example electronic funds transfer page 260. The electronic funds transfer (EFT) is used to capture the transfer of funds between bank accounts. Therefore, the EFT is directly related to transactions that post money from one account to another electronically and confirms the transfer of funds.

EFTs are generated by the financial institution's internal banking system directly via system integration or uploaded in a batch. EFTs are related to draws or reserve payments in a one to one relationship.

An EFT includes header information containing the beneficiary, funding source, to bank account information, date created and payment type. An EFT also includes financial institution and client bank account corresponding to the parties making and receiving the deposit. A history tab provides for displaying historical events associated with the EFT, such as when the EFT was uploaded or passed into the system, and how or when the EFT was applied to a draw or reserve payment. The history tab provides the link to view the related document. A description field may be used for descriptive purposes. Valid deposit type values are “batch” and “real time.”

An EFT may have status of uploaded and complete. An uploaded status indicates that the EFT has been uploaded into the system (in batch only). A complete status indicates that the EFT statement has been associated to the related draw or reserve payment.

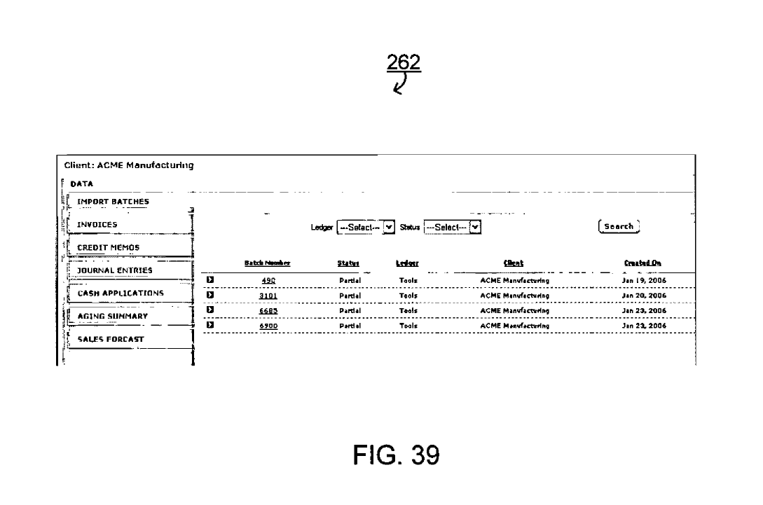

FIG. 39 is a screen image illustrating an example batch list page 262. The ABL system employs a batch processing technique for uploading electronic documents 144 and debtors 120 to the ABL application 116. Batch processing provides the capability to manage data records before they have been processed into the system. All management of exceptions and approvals of electronic documents 144 and debtor data records are performed within their associated batch file. Batches can themselves can be review and modified by the financial institution 108 to suit the financial institution's requirements. In addition, the batch contains all the information regarding the electronic documents 144 and debtors 120. This is extremely important should the financial institution 108 ever need to back-out a bath of records.

Batches are created as a result of a file upload from the client 102 or via direct data entry. The upload can be initiated via several mechanisms. Typically the files will be uploaded from the client interface. The electronic documents 144 addressed include the debtor, journal entry, credit memo, invoice, and cash application document types.

A batch defines a set of document types that have been uploaded or directly loaded into the system and help to track and organize them for later reference. Batches may include any number of record types including debtors, invoices, credit memos, journal entries, and cash applications. Batches may be created any time one or more of debtors, invoices, credit memos, journal entries and cash applications, are uploaded into the system. A batch includes the status of each individual record uploaded in that batch.

When multiple currencies exist within the batch, a new batch is created for each currency type. Each new batch references the original batch.

Batches include an error count for the errors that exist within the batch. Batches can be modified to correct erroneous data or to remove invalid documents. Historical information indicating when the batch was loaded is included in the batch. A batch includes the client name, ledger and a hyperlink to client details. A “details” hyperlink is included in the batch and displays a listing of all records contained in the batch. Users can hyperlink and view recorded details.

A batch may have status of pending, approved, rejected, canceled, errors and closed. Pending status indicates the batch has been uploaded but not yet approved. Approved status indicates that the batch has been either directly approved by the financial institution or automatically approved by the system, if available. Approved batches have no errors. Rejected status indicates that the system of financial institution 108 has rejected the batch. Canceled status indicates that the batch has been canceled by the client 102. Errors status indicates that a batch will remain in an error status until all debtor errors have been corrected. Only records having errors are excluded from being added into the system. Other records are added to their respective data store. For example, new debtors will now appear in the system and can be viewed and modified. Closed status indicates that all records on the batch have been fixed or removed.

The batch list includes a listing of batches that have not been closed. The financial institution 108 and the client 102 use the pending batch list to access the debtor error records contained in the batch and make the necessary corrections. The financial institution 108 can also set the clients AR ledger 122 so that all batches must be reviewed, and then accepted or rejected by a financial institution 108 user having the appropriate permissions.

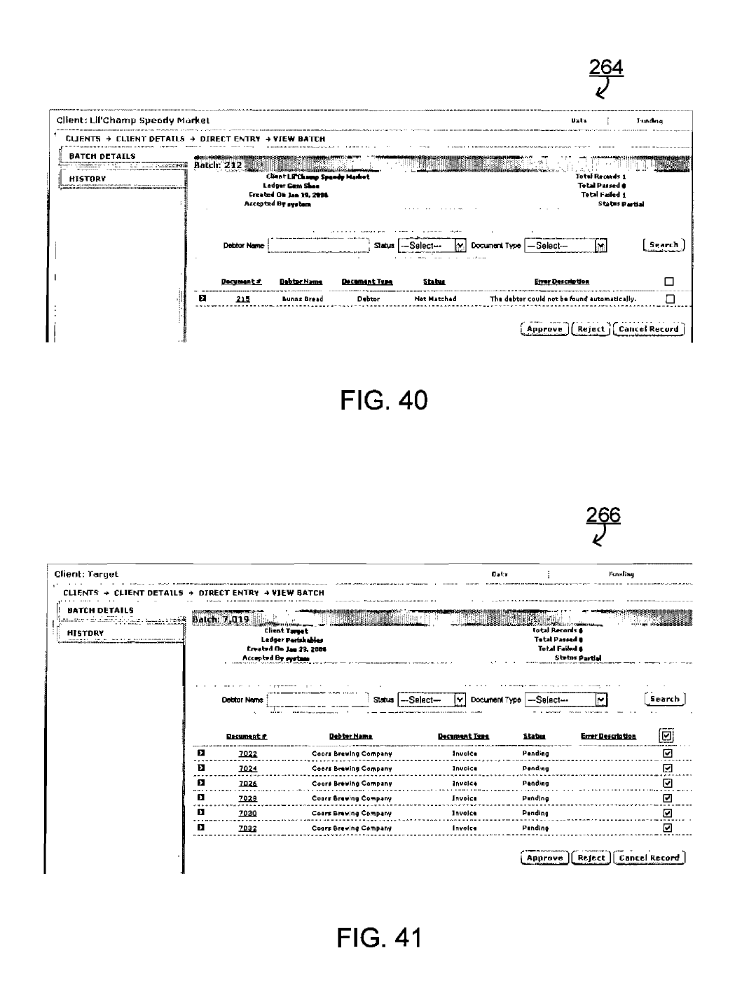

FIG. 40 is a screen image illustrating an example debtor batch list page 264 and FIG. 41 is a screen image illustrating an example invoice batch list page 266. The financial institution 108 and the client 102 view the batch detail records in order to correct debtor errors. The batch details page has the facility to search and find records having invalid debtors 120. Users can associate the invalid debtor to an existing debtor. In the case where the debtor 120 does not exist, the user can also add the debtor to the ABL system. When new debtors are added or an erroneous debtor is associated, the financial institution 108 must verify and activate the debtor 120 before any debtor e-documents 144 can be accepted. The detailed batch record has two tabs, a history tab as in FIG. 41 and a details tab as in FIG. 40.

Managing Client Web Page Elements

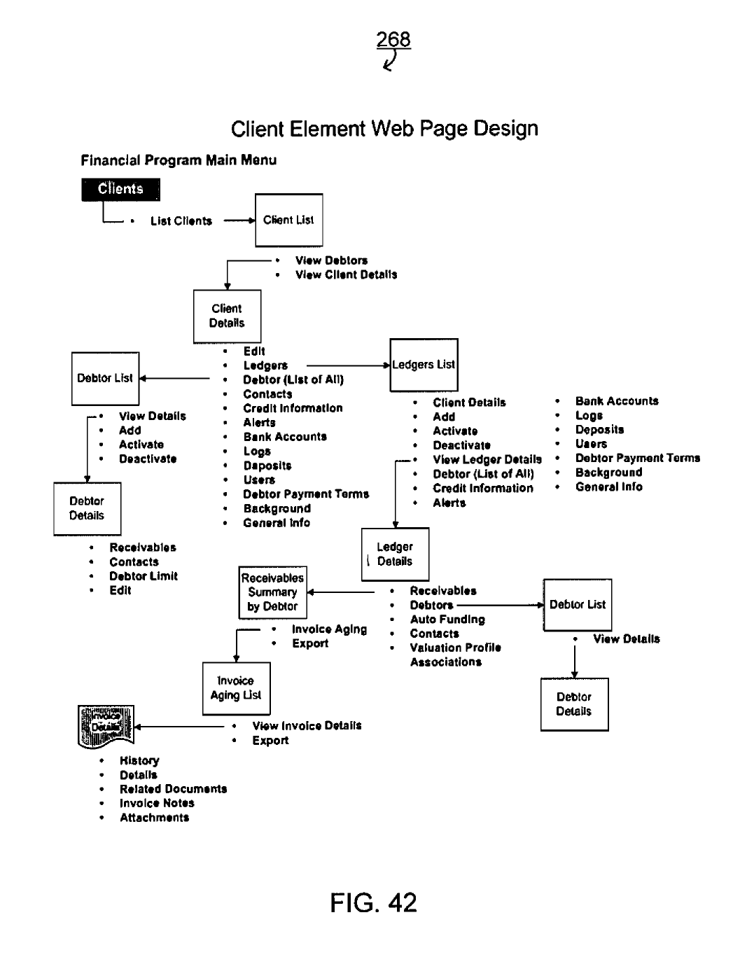

FIG. 42 is a diagram illustrating the client element web page design 268. The client web page diagram illustrates how the application web pages are organized within the financial institution function of the ABL application 116 from the perspective of the client element. The organization of these elements demonstrates their incorporation as building blocks into the system architecture to enhance design and functionality for the client 102.

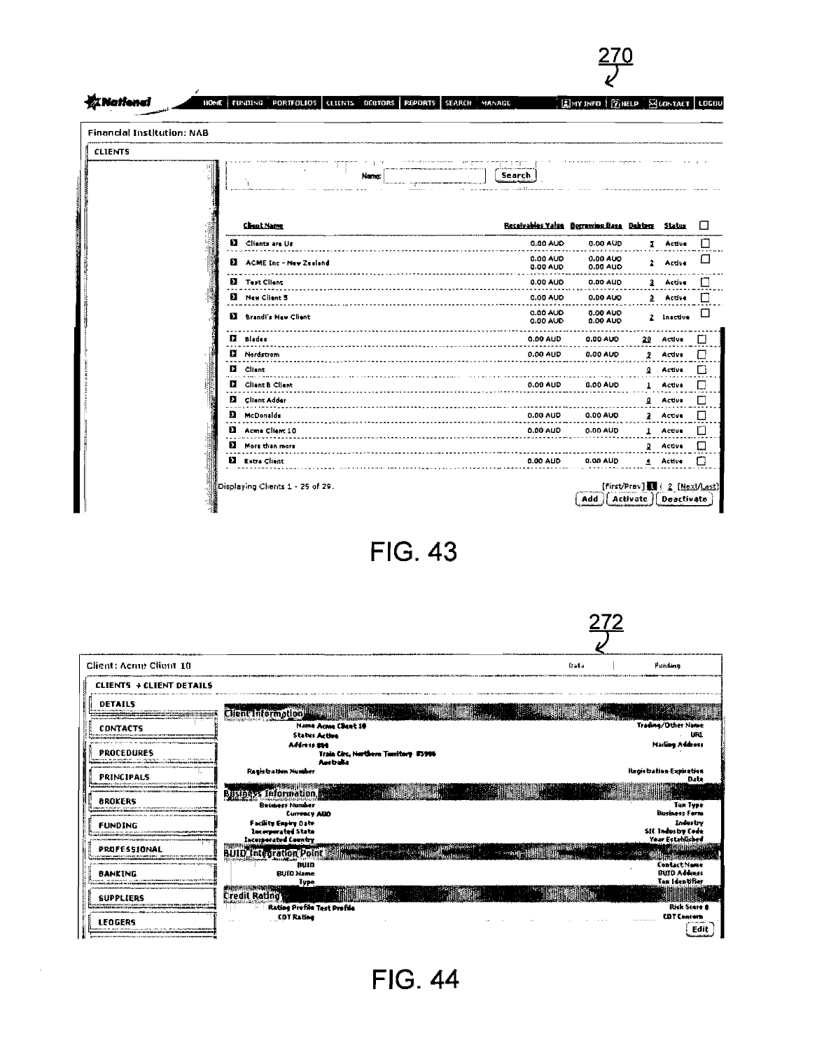

FIG. 43 is a screen image illustrating an example client list page 270. The client list is a list of the clients 102 that exist in the system without regard to ledgers. From the client list, the user has access to the client name, total receivables value, borrowing base, number of debtors and current status. Client 102 may be added, activated or deactivated.

FIG. 44 is a screen image illustrating an example client details page 272. The user may view the client information that the financial institution 108 has on file. The user may also edit the client 102 information.

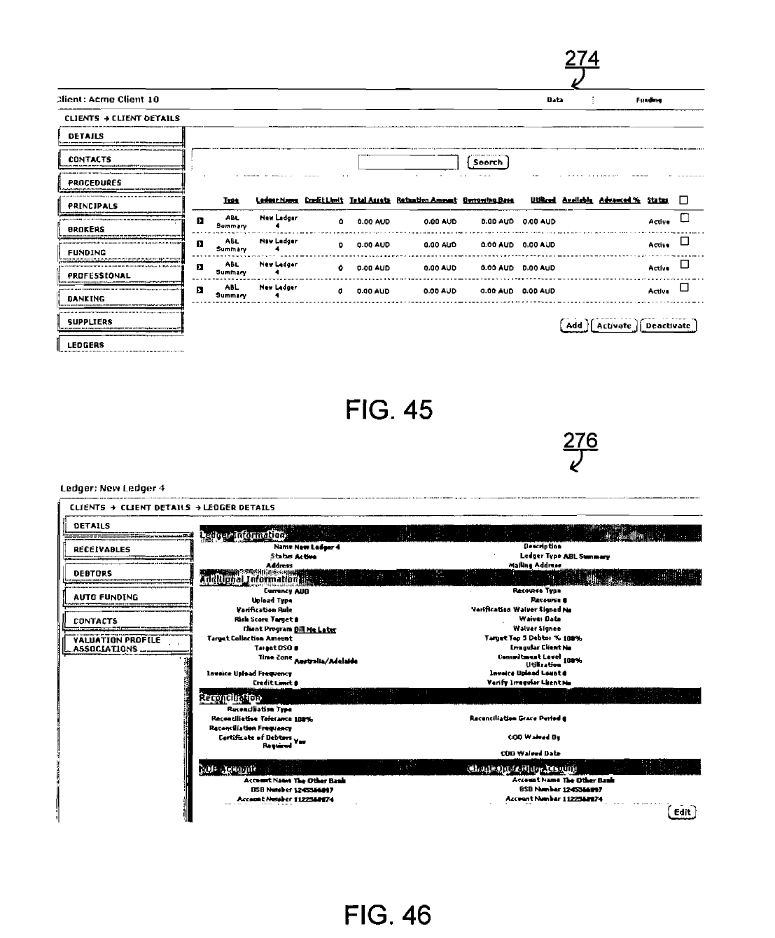

FIG. 45 is a screen image illustrating an example client ledgers list 274. Information shown on the client ledgers list includes ledger name, type, credit limit, total assets, retention amount, borrowing base, utilized, advanced percentage and status. From the client ledgers list page, the financial institution 108 user may view client AR ledgers 122, activate or deactivate ledgers, select a ledger name to view details or add a client 102.

FIG. 46 is a screen image illustrating an example client ledger details page 276. From the client ledger details page 276, the user may view ledger details, view or modify the auto funding, view the list of accounts receivables associated with the selected ledger, edit the ledger details, view valuation profiles associations, view ledger contacts or view a list of debtors 120 associated with the ledger.

Managing Debtor Web Page Elements

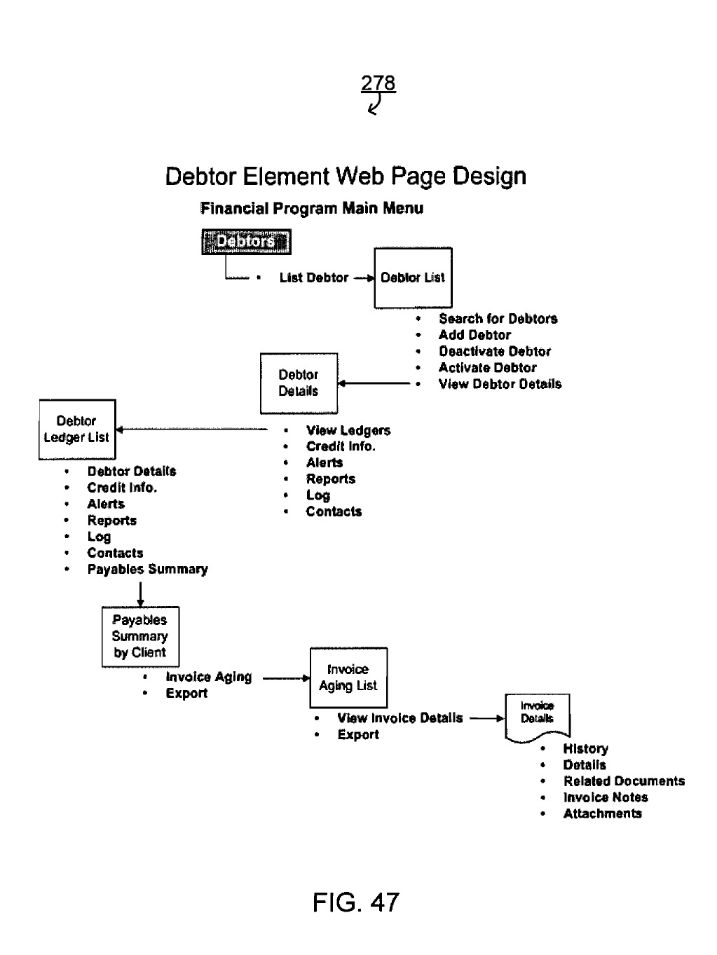

FIG. 47 is a diagram illustrating the debtor element web page 278 design. The debtor web page 278 diagram illustrates the organization of the application web pages within the financial institution function of the ABL application 116. The organization is from the perspective of the debtor element. The organization of these elements demonstrates how they are incorporated as building blocks into the system architecture to enhance the design and functionality for the debtor.

The debtor list allows the user to search for debtors, add a debtor, deactivate a debtor, activate a debtor or view debtor 120 details. The debtor details functionality allows the user access to view ledgers, credit information, alerts, reports, log and contacts. The debtor ledger list allows user access to debtor details, credit information, alerts, reports, log, contacts and payables summary. The payables summary by client 102 allows access to invoice aging and export. The invoice aging list allows access to view invoice details and export. Invoice details provides access to history, details, related documents, invoice notes and attachments.

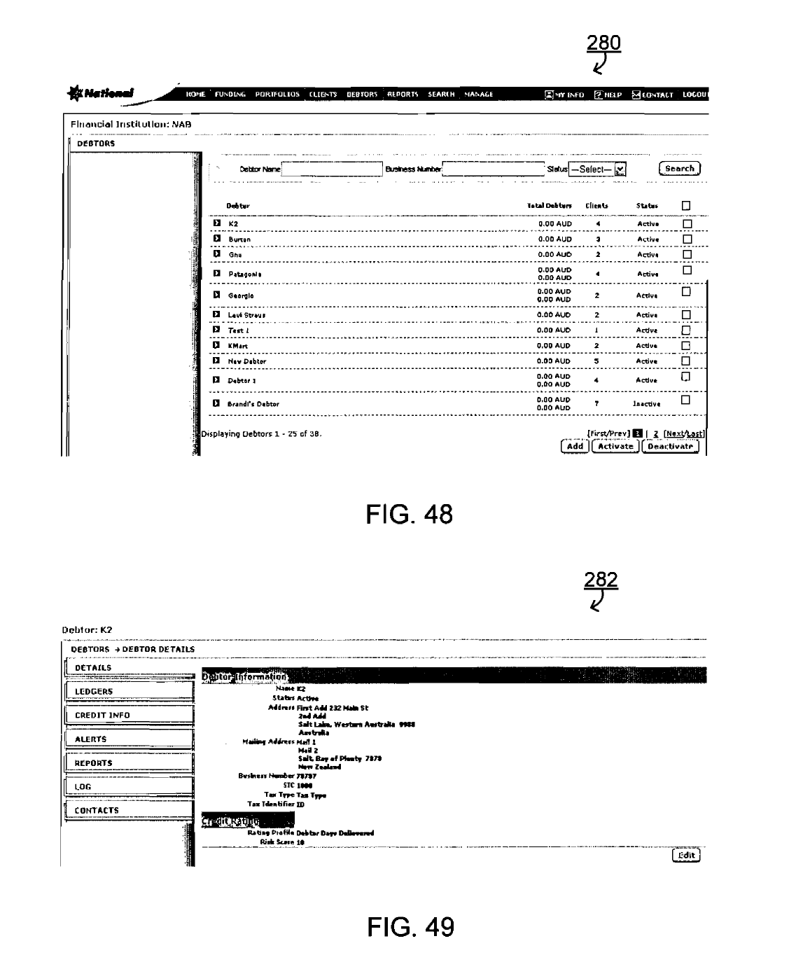

FIG. 48 is a screen image illustrating an example debtor list page 280. From the debtor list page 280, the user may access and maintain debtors. The list includes all debtors 102 in the system independent of ledger.

The debtors 102 are listed in alphabetical order, and if attached to multiple ledgers and currencies they are listed multiple times. The debtors list displays the debtor name, payables value (total debtors), clients and status.

From the debtor list page 280, the user may search for debtors by entering the debtor name (whole of partial) into the debtor textbox. Debtors 120 may also be searched address by entering the address (whole of partial) in the address field. Additionally, the debtors 120 may searched by status, business number or any combination of the previous fields.

A user may deactivate a debtor by clicking the checkbox and the associated deactivate button.

A user may activate a pending or deactivated debtor by clicking the check box and the associated activate button.

FIG. 49 is a screen image illustrating an example debtor details page 282. From the debtors details page 282, the user may access the details for the selected debtor 120 as well as the contacts that have been created for this debtor 120.

The user may edit debtor information. The contact tab provides access for viewing and adding a new contact. The ledgers tab provides access to debtor accounts payable ledgers. The credit info tab provides access to debtor credit information, and the log tab allows access to log information. Alerts may be configured via the alerts tab. The reports tab provides access for running reports.

Managing Application Table Elements

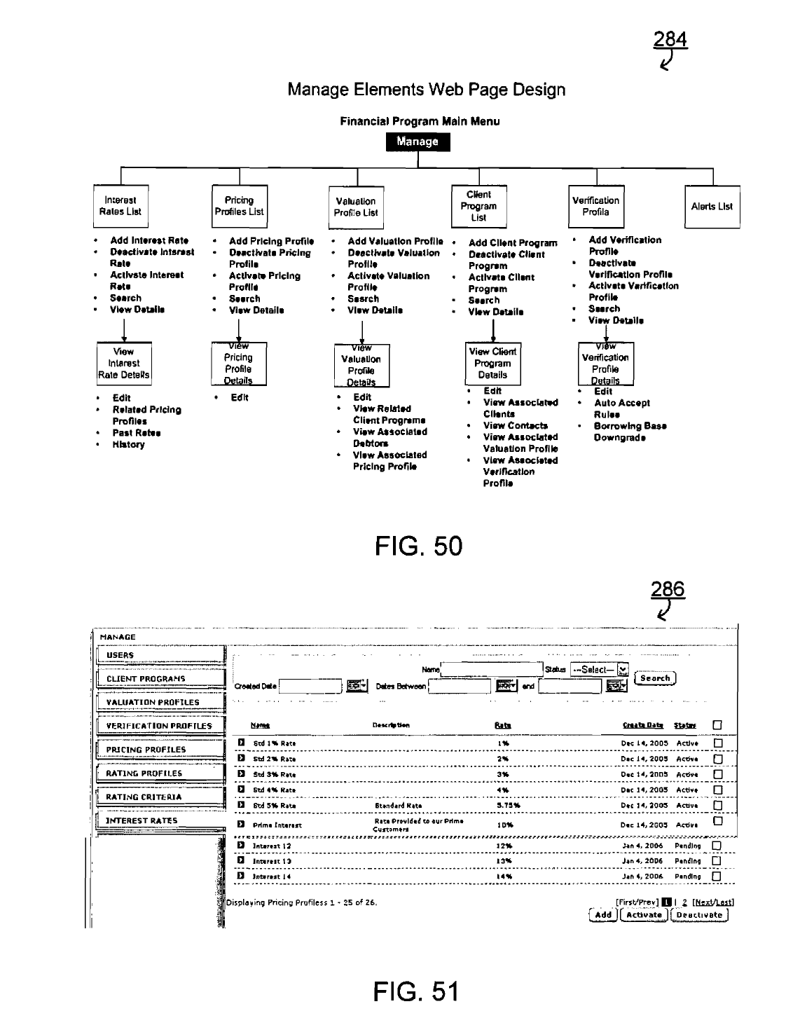

FIG. 50 is a diagram illustrating the manage elements 284 web page design. The ABL application uses a unique design structure of table elements that when combined enable financial institution users to configure the ABL application as required to meet their specific business needs. The table element design structure provides design benefits such as a building block concept, reusability, error checking, visibility, currency specific, searchable.

The building block concept allows the tables to be logically segmented in sub tables. This logical segmentation allows the financial institution to associate table elements to clients, debtors, portfolios and other table elements. The element relationships as presented in FIG. 3 above illustrate the building block concept.

Reusability provides that once a table entry has been created, it can be reused again and again. This reduces the amount of work by the financial institution 108 to set up and manage the ABL application 116.

Error checking allows the application to track each interrelationship and will not allow the financial institution user to deactivate a table element that is associated with another active element. Error checking also ensures that only table elements of the same currency can be associated.

The system allows for visibility of any relationships whereby table elements have been associated to one another. This helps the financial institution 108 to understand the impact upon the system when making changes to a table element.

Regarding currency, each table element will contain specific currency related information. Currency specific table elements can only be associated with other table elements of like currency.

Table elements are organized into searchable lists (extensive search capability) from which they can be viewed, edited, activated and deactivated.

The financial program main menu provides for managing the interest rates list, pricing profiles list, valuation profile list, client program list, verification profile, alerts list.

FIG. 51 is a screen image illustrating an example interest rates list 286 web page for managing interest rates. From the interest rates list 286 web page, the financial institution user may add an interest rate, view interest rate details, deactivate an interest rate, activate an interest rate and search for interest rates.

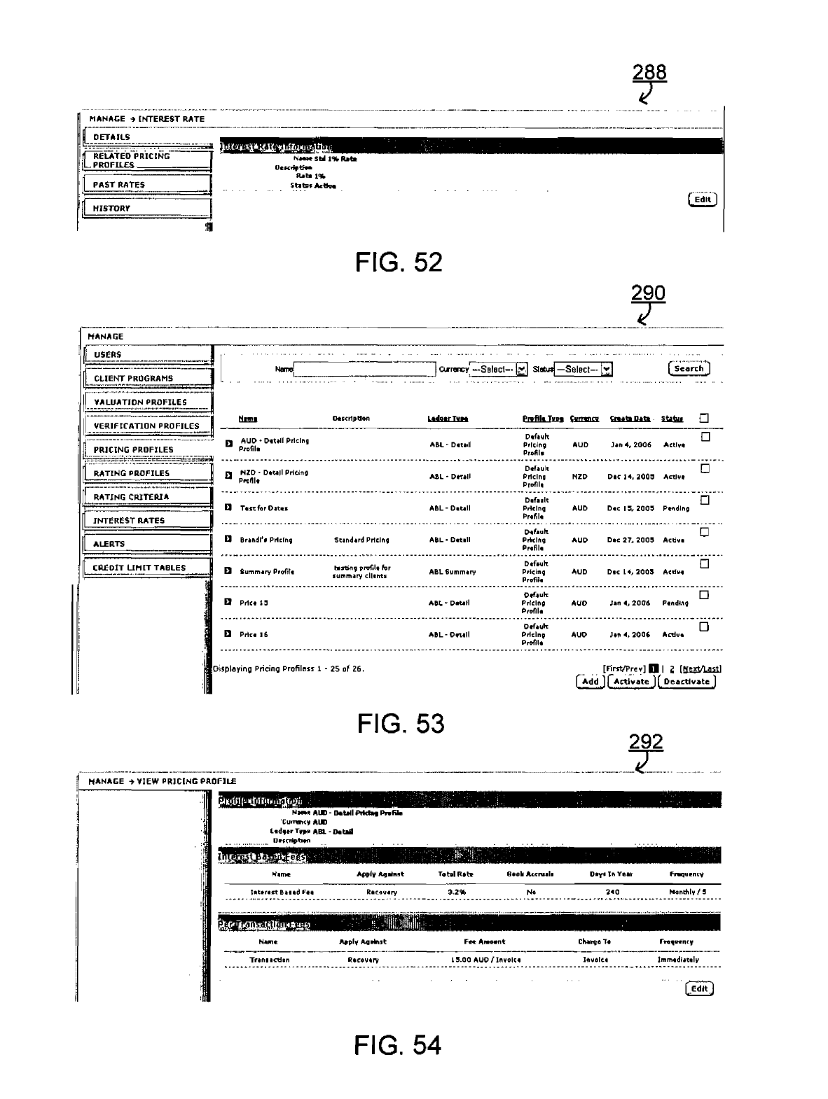

FIG. 52 is a screen image illustrating an example interest rates detail page 288 for accessing interest rate information. From the interest rates details page 288, financial institution users may edit the interest rate profile, view related pricing profiles 130 that are using that interest rate profile, view past rates for that profile and view the history of changes made to the interest rate profile.

FIG. 53 is a screen image illustrating an example pricing profile list page 290 for accessing pricing profiles details. From the pricing profile list page 290, the financial institution user may add a pricing profile, view pricing profile details, deactivate pricing profiles, activate pricing profiles and search for pricing profiles.

FIG. 54 is a screen image illustrating an example pricing profile details page 292. From the pricing profile details page 292, financial users may edit the pricing profile.

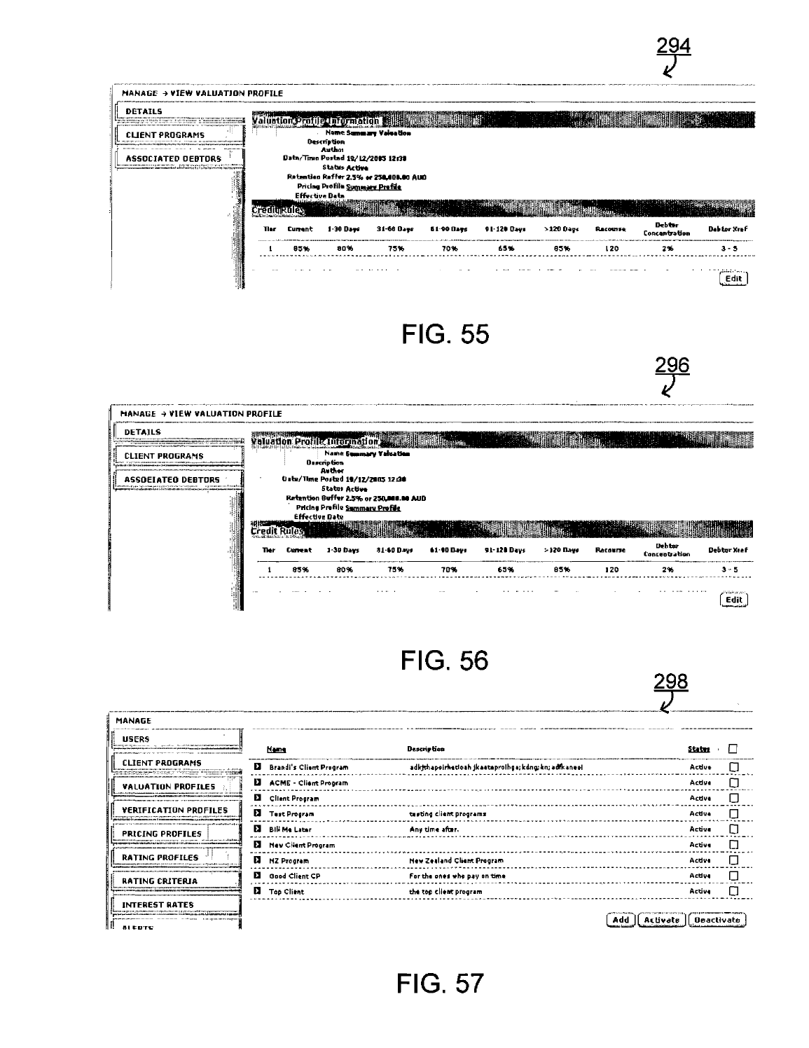

FIG. 55 is a screen image illustrating an example valuation profile list page 294. From the valuation profile list page 294, the financial institution user may add a valuation profile 128, view valuation profile details, deactivate valuation profiles 128, activate valuation profiles 128 and search for valuation profiles 128.

FIG. 56 is a screen image illustrating an example valuation profile details page 296. From the valuation profile details page 296, the financial user may edit the valuation profile 128, view any associated client program 126 and view any associated debtors 120.

FIG. 57 is a screen image illustrating an example client program list page 298. From the client program list page 298, the financial user may add a client program 126, view client program details, deactivate client programs 126, activate client programs 126 and search for client programs 126.

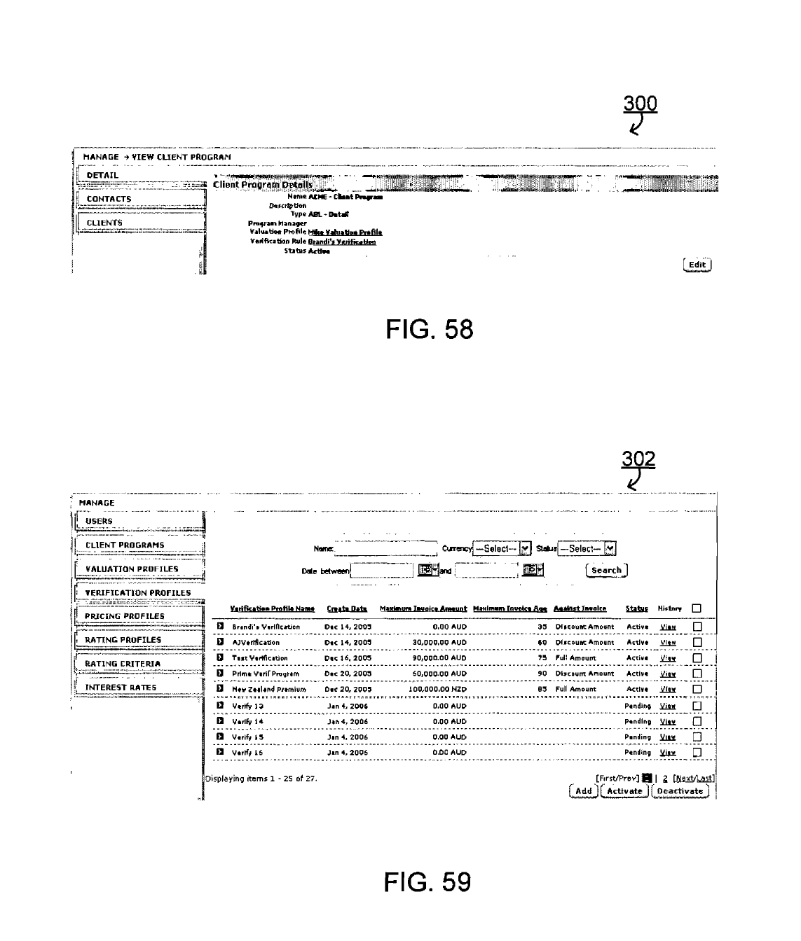

FIG. 58 is a screen image illustrating an example client program details page 300. From the client program details page 300, the financial user may edit the client program 126, view and edit client program contacts, view client program clients, view and edit the associated verification profile 136, and view and edit the associated valuation profile 128.

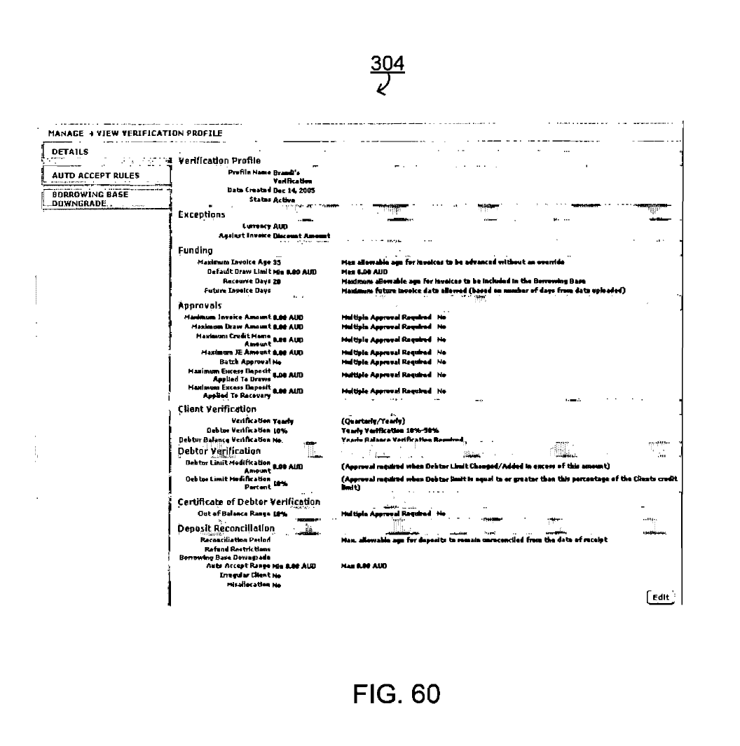

FIG. 59 is a screen image illustrating an example verification profile list page 302. From the verification profile list page 302, the financial user may add a verification profile 136, view verification profile details, deactivate verification profiles 136, activate verification profiles 136 and search for verification profiles 136.

FIG. 60 is a screen image illustrating an example verification profile details page 304. From the verification profile details page 304, the financial user may edit the verification profile 136, work with the auto accept rules and manage the borrowing base downgrade parameters.

Accordingly, it will be understood that various embodiments of the present invention described herein are preferably implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable to through wireless communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, some of the inventions are described in the general context of computer-executable instructions, such as program modules, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, or other input devices (not shown), such as a microphone, game pad, satellite dish, scanner, or the like. These and other input devices are often connected to the processing unit through known electrical, optical, or wireless connections.

The main computer that affects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

What is claimed is:

1. In an asset based lending system having a client and at least one financial institution, a method for valuing and pricing client's receivables, the method comprising:
downloading accounts receivable information from the client, the accounts receivable information having a specified currency;
calculating a borrowing base for the client via utilizing debtor risk ratings, pricing profiles, valuation profiles and pricing tiers; and
applying fees and interest as specified in the pricing profile associated with the valuation profile.

2. The method of claim 1, wherein the valuation profile further comprises configuring valuation tiers.

3. The method of claim 2, wherein the configuring valuation tiers further comprises determining the number of debtors to apply against each pricing tier based on a debtor's risk score.

4. The method of claim 2, wherein the configuring valuation tiers further comprises determining the percentage of the debtor's receivables to be included in the borrowing base.

5. The method of claim 2, wherein the configuring valuation tiers further comprises determining the age of the debtor's receivables to be included in the borrowing base.

6. The method of claim 2, wherein the configuring valuation tiers further comprises determining the percentage of any specific tier's debtors to be included in the borrowing base.

7. The method of claim 1, wherein the valuation profile further comprises:
selecting a client to test the valuation profile against;
comparing the valuation profile against the current account receivable ledgers to generate a new valuation profile;
comparing the borrowing base with the new valuation profile; and
adjusting the valuation profile to match the new valuation profile.

8. In an asset based lending system having a client and at least one financial institution, a method for valuing and pricing client's receivables, the method comprising:
receiving accounts receivable information from the client;
managing valuations, pricing and risk for the accounts receivable information;
applying fees and utilizing the valuations to calculate a borrowing base;
receiving a draw request from the client;
transferring funds to the client's operating account;
receiving a deposit from the client; and
upon notification of the deposit, re-calculating the borrowing base utilizing draw request information, deposit information and valuations.
